(19) United States
(12) Patent Application Publication
(10) Pub. No.: US 2002/0176651 A1
(43) Pub. Date: Nov. 28, 2002

(54) Modular fiber optic switch core

(76) Inventors: Jeffrey Scott, Carpinteria, CA (US); Pavan Gupta, Palo Alto, CA (US); William Cushman, Santa Barbara, CA (US); Elliot Burke, Goleta, CA (US); Theodore Shrode, Santa Barbara, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/102,623

(22) Filed: Mar. 19, 2002

Related U.S. Application Data
(60) Provisional application No. 60/277,479, filed on Mar. 19, 2001.
(60) Provisional application No. 60/277,480, filed on Mar. 19, 2001.

(51) Int. Cl. G02B 6/35; G02B 6/32

(52) U.S. Cl. 385/16; 385/33

(57) ABSTRACT

An optical switching core is disclosed that includes a plurality of input optical tiles and output optical tiles for directing optical beams between various input and output ports coupled to optical fibers. Each of the optical tiles includes a collimating optics array for transmitting a plurality of incoming optical beams and a transparent beam directing array optically coupled to said collimating optics array for redirecting said plurality of incoming optical. Two or more optical tiles are rotated about an optical axis with respect to one another to provide a compact, modular design. Drive electronics may be incorporated on tile or off tile to control the beam directing devices.

### CROSS REFERENCE TO RELATED APPLICATIONS

This application claims priority to U.S. Provisional Patent Application, Serial No. 60/277,479, entitled “HERMETIC MEMS TILE”, filed Mar. 19, 2001, and U.S. Provisional Patent Application, Serial No. 60/277,480, entitled “LENS FOR AN OPTICAL SWITCH” filed Mar. 19, 2001, the contents of both of which are hereby incorporated by reference.

### FIELD OF THE INVENTION

The present invention is generally related to fiber optic switches and more particularly relates to multi-port, non-blocking optical switches.

### BACKGROUND

Continuing innovations in the field of fiber optic technology have contributed to the increasing number of applications of optical fibers in various technologies. With the increased utilization of optical fibers, there is a need for efficient optical systems that assist in the transmission and the switching of optical signals. For example, there is presently a need for optical switches that direct the light signals from a set of input optical fibers to any of several output optical fibers, without converting the optical signal to an electrical signal. Light in this sense generally refers to the propagation of electromagnetic radiation and is not limited to the visible spectrum.

Various techniques may be utilized to couple optical fibers with a switch. For example, information may be digitally switched by converting the optical signal into a digital electrical signal, electrically routing the signal, and then regenerating an optical signal. This complex process offers the greatest traffic control but is very expensive and unnecessary for the majority of traffic passing through a switching node. Therefore, low-port-count MEMS-based optical switches are commonly used in communications systems to switch light from a plurality of input waveguides to a plurality of output waveguides without first converting the optical signal to an electrical signal. Such optical switches use MEMS mirrors as a reflective element, moving the mirror in or out of the path of a beam of light to redirect the optical signal path between stationary waveguides or collimating optics.

Many types of optical switches that utilize MEMS micro-mirrors have been proposed and tested. Two-dimensional arrays of bi-state micro-mirrors have been constructed that enable digital switching of optical signals. Monolithically interconnected arrays of 2×2 waveguide switches with thermal or electric field induced switching can provide the same function. This class of switches is commonly referred to as 2D due to their switching in a two-dimensional or planar surface. For a configuration with N inputs and N outputs, N² switching nodes are required.

However, as port counts rise above thirty two, the rapidly increasing number of nodes makes it very difficult to achieve a high manufacturing yield for conventional 2D switches. An alternative approach to strictly non-blocking optical switches is to enable analog beam directing out of the plane, sometimes referred to as 3D due to the three dimensional physical structure. Liquid crystal display technology has been adapted to switch direction of incoming light of known polarization. However, the use of general light requires complex optics that must be aligned on the input and output to split the light into two distinct states, switch the light through two parallel cores, then recombine the light.

Alternatively some 3D switch designs utilize individual beam directing units that may be formed into transmit and receive arrays that face each other. These have been made, for example, with piezoelectric driven collimating optics and magnetically actuated fibers. These systems have the ultimate granularity but their costs are high due to the individual alignment and assembly of each optical element within the individual beam directing units.

More recently 3D MEMS switches that utilize arrays of micro-mirrors to cross connect N input and M output fibers have been developed. Such 3D interconnects require a mirror for each input and output fiber to ensure that the light emanating from the transmitting fiber is directed to the desired port and then coupled into the receiving fiber. In these designs 2N mirrors are required to interconnect N inputs and N outputs. The reduced number of mirrors within a 3D design make such designs more suitable for high-port-count applications. Existing designs typically use 2 two-dimensional arrays of micro-mirrors facing each other with light making a zigzag path from the input optics array, to the first mirror array, reflecting to the second mirror array, then reflecting again to the output optics array.

These MEMS 3D switches have the advantages of compact size, low polarization dependence, and reduced packaging costs due to the use of arrays. The critical path, however, from the optics array to the corresponding mirror array is large due to the constraints of micro-mirror tilt angle, insertion-loss dependence on optical path length, and the physical arrangement of the optical path to avoid clipping on the facing mirror arrays.

In addition, conventional 3D MEMS switches require accurately alignment of the critical optical path to ensure that the collimated beams emanating from the fibers land on the corresponding micro-mirrors. If the beam is clipped by the edge of a mirror for example, diffraction may distort the beam and hence insertion loss for that port may rise significantly depending on the degree of clipping. Variation of the insertion loss from port-to-port and over mechanical and thermal stresses is highly undesirable for these critical optical transmission applications. Overcoming these critical path alignment limitations of existing 3D MEMS micro-mirror switch designs has proven very expensive and difficult. In addition, the optimized optical and assembly solution for one N×M configuration may need to be changed significantly to produce another, making the solution a point product instead of a scalable product that may be utilized over a wide range of port counts. The engineering costs of redesigns are often prohibitive, making it difficult to satisfy the varying demands of customers in the marketplace with conventional 3D MEMS switches.

### SUMMARY OF THE INVENTION

In one aspect of the present invention an optical switching core includes two or more input optical tiles, wherein each of the optical tiles includes a collimating optics array for transmitting a plurality of incoming optical beams and a transparent beam directing array optically coupled to the collimating optics array for redirecting the plurality of incoming optical beams to at least one of a plurality of output ports, wherein the two or more optical tiles are rotated about an optical axis with respect to one another.

In a further aspect of the present invention an optical switching core includes an input optical tile having an input collimating optics array optically coupled to an input transparent beam directing array, a second optical tile includes an output collimating optics array, having a plurality of output ports, optically coupled to an output transparent beam directing array and a frame, wherein the input optical tile is coupled to a first side of the frame and wherein the second optical tile is coupled to a second side of the frame, and wherein the input transparent beam steering array redirects a plurality of input optical beams transmitted by the collimating optics array to at least one of the plurality of output ports.

In a further aspect of the present invention a method of designing an optical switching core includes defining one or more switching core design constraints, defining one or more switching core performance constraints, determining diameter of incoming optical beam as a function of the switching core design constraints and modifying at least one of the one or more switching core design constraints or at least one of the one or more switching core performance constraints as a function of the diameter of the incoming optical beam.

### BRIEF DESCRIPTION OF THE DRAWING

These and other features, aspects, and advantages of the present invention will become better understood with regard to the following description, appended claims, and accompanying drawings where:

FIG. 1 is a simplified schematic diagram of an optical switch core having a plurality of input tiles, an input convergence lens, a frame, an output convergence lens and a plurality of output tiles having a plurality of output ports for redirecting a plurality of input beams to any one of the plurality output ports in accordance with an exemplary embodiment of the present invention;

FIG. 2 is a perspective view of an exemplary optical tile for use in the switch core of FIG. 1, comprising a collimating optics array, a transparent beam directing array and drive electronics for use in accordance with an exemplary embodiment of the present invention;

FIG. 3 is a perspective view of an array of beam directing devices formed by rotating four of the tiles of FIG. 2 about an optical axis with respect to one another in accordance with an exemplary embodiment of the present invention;

FIG. 4 is a cross sectional view of an exemplary convergence lens of FIG. 1 for shifting scan area of redirected optical beams towards an optical axis in accordance with an exemplary embodiment of the present invention;

FIG. 5 is a cross sectional view of an exemplary beam combiner of FIG. 1 for optically eliminating the space between optical tiles in the beam directing array of FIG. 3 in accordance with an exemplary embodiment of the present invention;

FIG. 6 is a plan view of an exemplary optical design of the beam directing array of FIG. 3 optically viewed through the beam combiner of FIG. 5 in accordance with an exemplary embodiment of the present invention;

FIG. 7 graphically illustrates the cone scanned by the redirected optical beams in the optical switch core of FIG. 1 in accordance with an exemplary embodiment of the present invention;

FIG. 8 is a flow chart of a process for optically designing the switch core of FIG. 1 in accordance with an exemplary embodiment of the present invention;

FIG. 9 is a graphic illustration of the optical path of the switch core of FIG. 1 in accordance with an exemplary embodiment of the present invention;

FIG. 10 is a cross sectional view the transparent beam directing device of FIG. 2 in accordance with an exemplary embodiment of the present invention;

FIG. 11 is a cross sectional view of the transparent beam directing array of FIG. 2 optically coupled with the collimating optics array of FIG. 2 in accordance with an exemplary embodiment of the present invention;

FIG. 12 is a planview of the optical design of the beam directing array of FIG. 3 optically viewed through the beam combiner of FIG. 5 in accordance with an exemplary embodiment of the present invention;

FIG. 13 is a cross sectional view of a switch core having multiple input tiles and multiple outputs tiles integrated on opposite sides of the frame of FIG. 1 in accordance with an exemplary embodiment of the present invention;

FIG. 14 is a cross sectional view of a switch core having multiple output tiles integrated perpendicular to multiple input tiles by a frame having a 45° reflector for redirecting beams exiting the input tile to the output tile in accordance with an exemplary embodiment of the present invention;

FIG. 15 is a cross sectional view of a switch core having a frame with a retro-reflector so that multiple input tiles may address themselves, making the input and output address planes coincident in accordance with an exemplary embodiment of the present invention;

FIG. 16 is a cross sectional view of the convergence lens of FIG. 2 demonstrating wherein the focal length of the lens is equal to the distance between the lens and the address plane in accordance with an exemplary embodiment of the present invention;

FIG. 17 is a cross sectional view of the convergence lens of FIG. 2 graphically illustrating the shifting of the scan area of redirected beams toward a common optical axis in accordance with an exemplary embodiment of the present invention;

FIG. 18 is a cross sectional view of the convergence lens of FIG. 2 graphically illustrating the dependence of the effective scan area of the beam directing device on the object distance of the convergence lens in accordance with an exemplary embodiment of the present invention;

FIG. 19 is a cross sectional view of a the convergence lens of FIG. 2 wherein a single convergence lens is integrated into the optical path of redirected rays from multiple independent beam directing units in accordance with an exemplary embodiment of the present invention;

FIG. 20 is a cross sectional view of the convergence lens of FIG. 2 wherein a single convergence lens is integrate in the optical path of redirected rays from multiple independent beam directing units wherein the convergence lens is effectively cut into pieces matching the spacing between the separate beam directing units in accordance with an exemplary embodiment of the present invention;

FIG. 21 is cross sectional view of the convergence lens of FIG. 2 wherein a separate convergence lens is coupled to each beam directing unit and the optical axis of each of the convergence lenses may be aligned with the optical axis of the beam directing array in accordance with an exemplary embodiment of the present invention;

FIG. 22 is a planview of an optical design of a beam directing array comprising four common tiles rotated about an optical axis with respect to one another with a portion of reflector strips illustrated above a portion of the beam directing devices for redirecting an incoming optical beam from a collimating optic to an associated beam directing device in accordance with an exemplary embodiment of the present invention;

FIG. 23 is a cross sectional view graphically illustrating the performance of the beam combiner of FIG. 5 in accordance with an exemplary embodiment of the present invention;

FIGS. 24 a and b are planview illustrating the reduction in scan area required to compensate for separation between multiple beam directing arrays as provided by the beam combiner of FIG. 23 in accordance with an exemplary embodiment of the present invention;

FIG. 25 is a graphical illustration of the performance of the beam combiner of FIG. 23 in accordance with an exemplary embodiment of the present invention;

FIG. 26 is a graphical illustration of the performance of beam combiner of FIG. 23 as a function of incidence angle and index of refraction of the beam combiner and surrounding medium in accordance with an exemplary embodiment of the present invention;

FIG. 27 is a schematic cross section of an exemplary four-tile beam directing array with beams being scanned by the beam directing devices to address the output ports through the beam combiner of FIG. 23 in accordance with an exemplary embodiment of the present invention;

FIG. 28 is a schematic cross section of a reflective beam combiner having surface formed at acute angles for compensating for separation between multiple beam directing arrays in accordance with an exemplary embodiment of the present invention;

FIG. 29(a) is an exploded perspective view of the tile with a transparent beam directing array separated from the collimating optics array in accordance with an exemplary embodiment;

FIG. 29(b) is a perspective view of a tile having a transparent beam directing array and collimating optics array coupled with the transparent beam directing array in accordance with an exemplary embodiment of the present invention;

FIG. 30(a) is a cross sectional view of the tile of FIG. 29(a) illustrating the path of the optical beams traveling from the collimating lens through the transparent beam directing array and into and out of the convergence lens in accordance with an exemplary embodiment of the present invention;

FIG. 30(b) is a planview of the underside of the upper window illustrating the integration of the high reflectivity strips in accordance with an exemplary embodiment of the present invention;

FIG. 30(c) is a top view of the tile of FIG. 30(a) with the lid removed wherein the MEMS mirrors are arranged in strips in accordance with an exemplary embodiment of the present invention;

FIG. 31 is an exploded view demonstrating the assembly process of the optical tile of FIG. 30(a) having a transparent beam directing array that forms a hermetically sealed environment in accordance with an exemplary embodiment of the present invention;

FIGS. 32(a) and (b) are top and bottom perspective views of the collimating optics array having a collimator plate and individual collimating optical lenses mounted thereto in accordance with an exemplary embodiment of the present invention;

FIG. 33 is an exploded view of optical switch core wherein a plurality of input tiles face a plurality of output tiles in accordance with an exemplary embodiment of the present invention;

FIG. 34 is a perspective view of a four parallel plate beam combiner and the mounting bracket that couple the beam combiner to the web in accordance with an exemplary embodiment of the present invention;

FIG. 35 shows an exploded view of an optical switch core in accordance with an exemplary embodiment of the present invention; and

FIG. 36 is a perspective view of a fully assembled optical switch core in accordance with an exemplary embodiment of the present invention.

### DESCRIPTION OF THE INVENTION

An exemplary embodiment of the present invention comprises a modular fiber optic switch core that readily scales over a wide range of port counts. Presently there are a broad range of applications for high speed optical switches such as, for example, optical cross connects, wavelength cross connects and optical add drop multiplexers. Many are described, for example, in “Optical Cross-Connect Generic Requirements, GR-3009-CORE” issue 2, December 1999 by Telcordia Technologies the content of which is hereby incorporated by

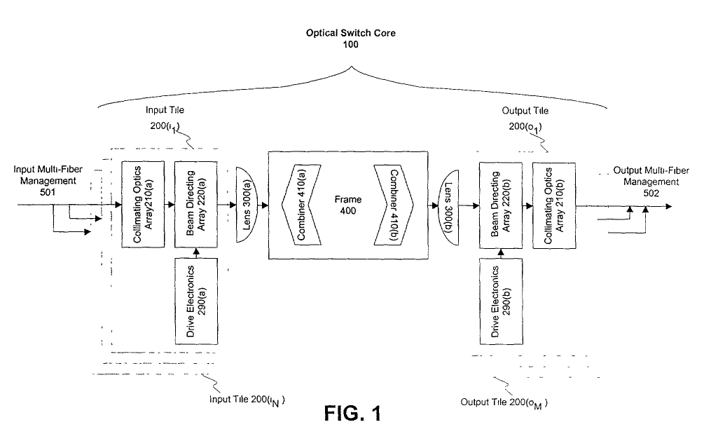

FIG. 1 is a simplified block diagram of the described exemplary switch core 100. The switch core enables simultaneous connection from any of a plurality of input fibers 501 to any of a plurality of output fibers 502. In the described exemplary embodiment input and output tiles 200(i₁-i_{N}) and 200(o₁-o_{M}) respectively, perform the switching function. In an exemplary embodiment a frame 400 may be utilized to hold the tiles in fixed mechanical positions. The number of ports within the described exemplary switch core scales in increments of input and output tiles. In the described exemplary embodiment the frame may be symmetric allowing for the use of common input and output tiles, making the described exemplary switch core modular and scalable over a wide range of switch ports without having to retool the design or store multiple parts in inventory.

In an exemplary embodiment, an input multi-fiber management system 501 may be utilized to couple a plurality of optical waveguides to the switch core. The fibers may be distributed to any one of the N input tiles 200(i₁-i_{N}). In an exemplary embodiment the optical waveguides may be coupled to a collimating optics array 210(a) that converts the guided optical beams transported by the optical waveguides into expanded Gaussian beams having diameters and waist positions that are optimized for the switch core's optical path. The light exiting the collimated optics array 210(a) can be thought of as collimated beams to first order. The collimated beams may then be coupled to a transparent beam directing array 220(a) that redirects the incoming collimated beams to any one of the plurality of output fibers. One of skill in the art will appreciate that the array is not limited to uniform grids but may also generally include non-uniform clusters of beam directing devices as may be preferred for a particular application.

In the described exemplary embodiment the collimating optics array 210(a) may be passively aligned with the transparent beam directing array 220(a) using datums or precision alignment pins. Further, the described exemplary transparent beam directing array provides a short optical lever arm that reduces the alignment tolerances of the various optical components allowing for the use of mechanical machining or injection molding manufacturing techniques. In addition, the described exemplary collimating optics array and the transparent beam directing array may be independently manufactured and then passively assembled.

The described exemplary transparent beam directing array 220(a) is a transparent package that contains multiple beam directing devices (not shown). In an exemplary embodiment, each beam in the collimating optics array may be coupled to a unique beam directing device. In operation, the incoming light may enter the transparent beam directing array on one side, such for example the floor, and exit the transparent beam directing array on an opposing side, such as, for example the ceiling. In the described exemplary embodiment the beam directing devices may redirect the angle of the incoming beams, pointing them to any one of a plurality of ports on any one of the output tiles 200(o₁-o_{M}) . In an exemplary embodiment, the beam directing devices can redirect the beams in both axis subject to a maximum deflection, effectively scanning a cone centered around the angle of the beam as it exits the transparent beam directing array when the beam directing devices is in its relaxed or unactuated state.

Features of exemplary beam directing arrays and packages are disclosed in the following commonly owned and currently pending U.S. patent applications, the contents of all of which are hereby incorporated by reference: Ser. No. 09/549,799, filed Apr. 14, 2000, entitled “MODULAR APPROACH TO SUBSTRATE POPULATION IN A FIBER OPTIC CROSS CONNECT;” Ser. No. 09/549,789, filed Apr. 14, 2000, entitled “FIBER OPTIC CROSS CONNECT WITH TRANSPARENT SUBSTRATE;” and Ser. No. 09/990,476, filed Nov. 20, 2001, entitled “DOUBLE HERMETIC PACKAGE FOR FIBER OPTIC CROSS CONNECT.” The described exemplary transparent beam directing array 220 allows the collimating optics array 210 to be closely coupled to the beam directing devices. The close proximity of the collimating optics provides a relatively short lever arm that allows the collimating optics array and the transparent beam directing array to be aligned with the necessary tolerances using much lower cost methods as compared to other 3D MEMS switches. For example, in an exemplary embodiment the collimating optics may be passively aligned with the corresponding beam directing devices counting only on the collimator assembly process and standard machining tolerances.

In the described exemplary embodiment each beam directing device on a tile may be controlled by signals from corresponding drive electronics 290. The drive signals may be simple voltages, currents or digital signals depending on the complexity of the beam directing devices. For example, if the beam directing device is an element in an electrostatic MEMS micro-mirror array three control voltages are typically used per mirror along with a common ground per array. An exemplary embodiment of a suitable MEMS micro-mirror is disclosed in U.S. Pat. No. 6,283,601, entitled “OPTICAL MIRROR SYSTEM WITH MULTI-AXIS ROTATIONAL CONTROL,” the content of which is hereby incorporated by reference.

In the described exemplary embodiment the beam directing devices may be mounted on a substrate that routes wire-bonded traces from the mirror interconnects to an interface with the drive electronics. The described exemplary embodiment may fan out the signal traces to reduce the density of the electronics interface. For example, a 256 element mirror array requires nearly 800 interconnects that may be difficult to attain in a high density, space limited design. In addition, in an -exemplary embodiment the drive electronics may generate control signals in response to digital commands from a serial data stream. Thus the interface between the drive electronics and a switch control system (not shown) may be reduced to a simple serial bus interface.

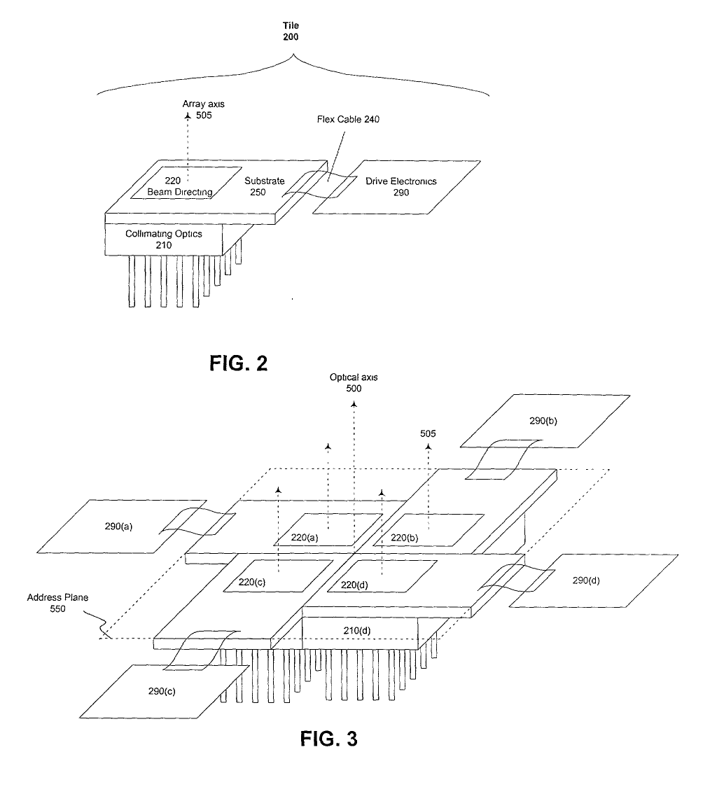

In an exemplary embodiment of the present invention, the collimating optics array 210, the transparent beam directing array 220 and the drive electronics 290 form a tile 200. One of skill in the art will appreciate however, that the input and output tiles 200(i₁-i_{N}) and 200(o₁-o_{M}) respectively may be formed from substantially the same components but also may comprise different components. FIG. 2 is a perspective view of an exemplary tile embodiment. In the described exemplary embodiment, incoming optical beams of an input tile enter through the floor of the tile and exit through the top of the tile. In one embodiment the drive electronics 290 may be electrically interconnected along the periphery of a transparent beam directing array substrate 250. In the described exemplary embodiment, a flex ribbon cable 240 or other low density interconnect may be used to electrically couple the drive electronics 290 with the transparent beam directing array 220.

An exemplary four tile embodiment is conceptually illustrated in FIG. 3, where the tiles 200(a-d) are located in a common address plane around an optical axis 500 of the switch core. In the described exemplary embodiment, the periphery of the substrate 250 away from the optical axis is not space limited. Therefore, interconnects formed at the periphery can be made at a spatial density appropriate for existing interconnect technology such as flex cable, ribbon cable, high density connectors and thick and thin film patterning.

In addition, the described exemplary “tiled” design may be readily scaled simply by placing two or more tiles side by side because neither the optics or the electronics of a given individual tile interfere with the other tiles in the array. In addition, in one embodiment, a multi-tile array may be formed from two or more common tiles by symmetrically rotating the described exemplary tile around the optical axis 500 of the switch, further reducing the number of parts required to scale the number of ports in a switching core. One of skill in the art will appreciate that the described exemplary switch core is not limited to four tiles. Rather the switch core may be extended to include more than four tiles by using wedge shaped tiles or by altering the symmetry of the design by using tiles that vary slightly in shape such as rectangles. In the described exemplary embodiment, the frame 400 (see (FIG. 1) holds together the multiple tiles of FIG. 3. The port of an exemplary switch core may therefore be scale up to four times with the same tile 200. While four tiles are illustrated in the exemplary embodiment, it is understood that N input and M output tiles may be used as illustrated in FIG. 1.

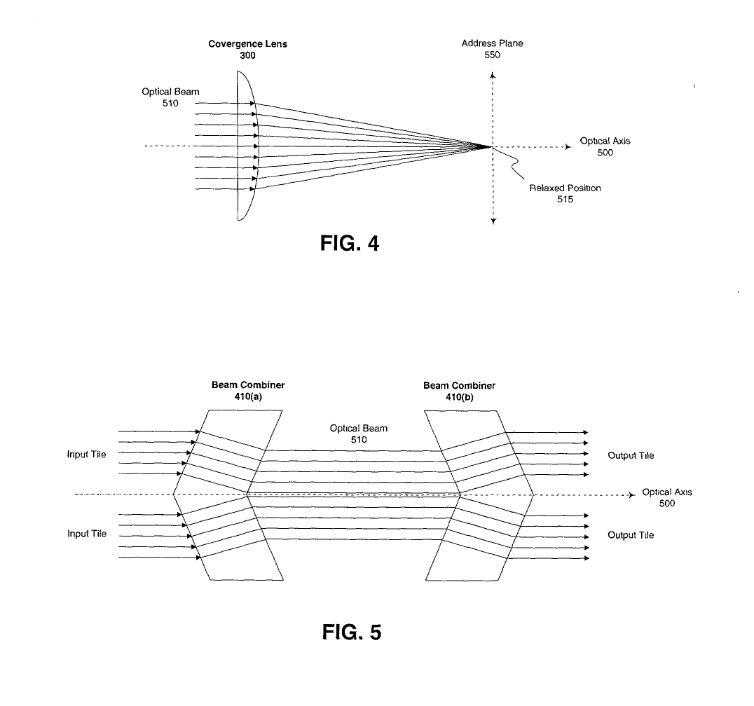

Referring back to FIG. 1, redirected beams that exit the input tile 200 may be optically coupled to a convergence lens 300. In the described exemplary embodiment the convergence lens provides a unique compound angle to each of the redirected beams and converges all of the beams in their relaxed position 515 to a common point at the center of the output tile array as shown in FIG. 4. Thus the scan cones of each beam overlap on the output address plane, increasing the number of ports that may be addressed with a given deflection of the beam directing devices.

In the described exemplary embodiment the convergence lens 300 may be coupled or referenced to the optical surface of the tile 200 or held in position by the frame 400. In the described exemplary embodiment, the design of the collimating optics preferably accounts for the effects of the power of the lens on the propagation of the optical beam.

The described exemplary convergence lens is a simple method of introducing the unique compound angles and makes the design of each switching element of the tile 200 substantially the same. However, one of skill in the art will appreciate that the unique compound angles may be introduced in the collimating optics array or the transparent beam directing array to converge the redirected beams to a common point. Therefore, the described exemplary switch core having a convergence lens is by way of example only and not by way of limitation.

Returning to FIG. 1, upon exiting the convergence lens the optical beams enter the frame 400. In the described exemplary embodiment the frame mechanically supports the tiles, and physically separates the tile so that the scan cone of the input tiles extends across the output ports. The frame may also control the switching environment so that dust or other contaminants do not degrade the optical beams.

In an exemplary embodiment of the present invention, the frame may include a pair of beam combiners 410(a) and 410(b). In the described exemplary embodiment the beam combiners shift the optical beams to allow the input and or output tiles to be physically separate while making the port arrays of each tile appear optically adjacent. Referring to FIG. 5 the described exemplary beam combiners are parallel plate beam shifters that shift the beams as shown. For purposes of clarity the optical beams 510 are shown traveling straight across to their corresponding port rather than in their relaxed state. In accordance with an exemplary embodiment the beam combiners may include an anti-reflective coating to reduce the insertion loss and polarization-dependant loss associated therewith.

In operation the refractive parallel plates shift the beams towards the optical axis 500 without affecting the scan angle of the beam directing devices. The described exemplary beam combiners allow for the physical separation of the beam directing arrays without using scan angle to cover the “dead zone” between the arrays where there are no ports. Since scan half-angle is often limited to 5-10 degrees, saving two to three degrees can be highly advantageous. In addition, separation of the tiles provides space for tile package seals, as well as space for mounting the tile to the frame and potentially for interconnect routing. However, the parallel plate beam combiners are not necessary for proper operation of the described exemplary switch core. Rather, the described exemplary switch core having a parallel plate beam combiner is by way of example only and not by way of limitation.

Returning again to FIG. 1, the optical beams transverse both beam combiners 410(a,b), exit the frame 400 and follow an essentially symmetric path through the convergence lens 300(b) and output tiles 200(o₁-o_{M}) and out of the switch core. In the described exemplary embodiment symmetry of the switch core may be further enhanced by locating the waist of the Gaussian beam at the center of the frame.

In operation, the beam directing devices steer associated input beams to any one of the plurality of output ports in the output tile by pointing to the appropriate output beam directing device. The output tile's beam directing device adjusts its angle to ensure the light couples into the associated output fiber. In one embodiment, the beam directing device angles for each connection are unique and the required control signals for each connection may be stored in the control electronics memory or software based on prior testing.

One of skill in the art will appreciate that the number of input or output tiles may be configured as desired. As illustrated in FIG. 1 an exemplary switch core may comprise M output tiles, where M is not necessarily equal to the number of input tiles N. Input and output tile designs and numbers can be the same or different depending on the application. One configuration (not shown) may integrate a mirror in the center of the frame to reflect incoming light back towards the input tiles which may then function as both input and output ports.

The components of the described exemplary 3D switching core, including the frame, tiles, and elements within the tiles are interchangeable and may be mated with passive connections and standardized interfaces. An exemplary embodiment may also use passive alignment and interchangeable parts to reduce cost and enhance manufacturing yield while simplifying manufacturing logistics. This is particularly advantageous when providing a switch core spanning a wide range of port counts.

Optical Design

The described exemplary switch core may be designed in accordance with the limiting case as determined by the maximum scan angle of the beam directing devices. The following optical design analysis assumes that the switch core is symmetric, i.e. N=M in FIG. 1. If the port count is not symmetric the analysis should be conducted for both switching directions i.e. from input tiles to output tiles and from output tiles to input tiles.

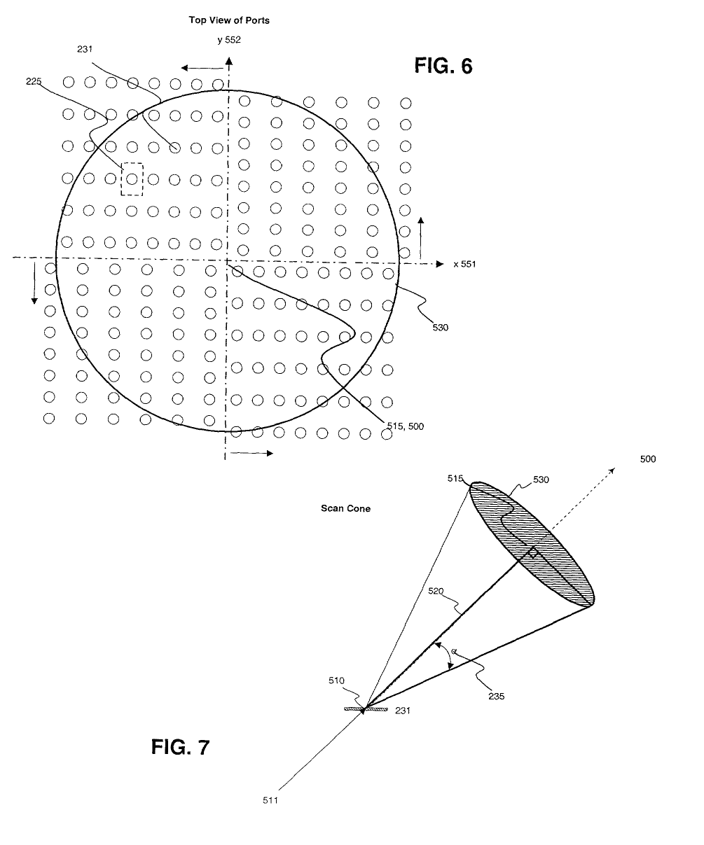

FIG. 6 is a planview of an exemplary array of beam directing devices 231, that corresponds to the ports in an address plane. In the described exemplary embodiment a rectangle may be used to define a unit cell area 225, i.e. the area of a single cell of the beam directing device within the array, viewed from the top. In a rectangular array the unit cell area is the product of the device-to-device pitch in the x direction 551 and y direction 552 within the address plane. The analysis presented here applies equally to a single tile array or a multiple tile array as illustrated in FIG. 6.

In each quadrant an arrow illustrates an exemplary design layout comprising a single tile rotated four times around the optical axis 500. Scan area 530 illustrates the projection of the scan cone onto the address plane, centered on the relaxed position 515. The total number of ports that the beam directing devices may is the number of beam directing devices 231 falling within the scan area 530. Therefore the scan area is equal to the product of the port count and the unit cell area as provided in Eq. 1.

scan area=unit cell·port count Eq.(1)

The scan area 530 is also related to the path length 520, and the scan angle 235 as illustrated in FIG. 7. In operation an incident optical beam 510 from the collimating optics reflects off of a beam directing device 231. The beam traverses to the relaxed position 515 without scanning. As the beam directing device changes the beam's direction, up to the maximum scan angle 235, the beam scans out a cone around the relaxed position. In the described exemplary embodiment the relaxed position may be located at the intersection of the optical axis 500 with the address plane. In the case of a reflective scanning mirror, the optical half angle, α, is equal to the full mechanical tilt angle of the beam directing device. The analysis also applies to transmissive beam directing devices as shown by incident beam 511. In the described exemplary embodiment the scan area is related to the path length and scan angle, α, as provided in Eq. 2

scan area=T(path length·tan(α))² Eq. (2)

Eqs. 1 and 2 may be solved to determine the path length as a function of the port count, maximum scan angle of the beam directing devices and unit cell area as provided in Eq. 3.

$$path length = \frac{1}{tan ( α )} {( \frac{unit cell \cdot port count}{π} )}^{1 / 2} \qquad Eq . ( 3 )$$

This analysis assumes that the scan pattern is circular and that the beam directing devices lie on the optical axis. This analysis further assumes that all the relaxed positions fall onto the center of the receive array. One of skill in the art will appreciate that a different geometrical scale factor may be used to accommodate non-circular patterns such as an ellipse when the beam directing devices are offset from the optical axis. One of skill in the art will further appreciate that the described exemplary optical design analysis may be extended to non-coincident relaxed beam positions by considering the intersection of overlapping circles or scans patterns.

Once the path length required to achieve the desired port count is determined, the optical beam size can be calculated using well-known equations for Gaussian beam propagation. The described exemplary embodiment may utilize the minimum optical beam size at the beam directing devices in order to increase port count and minimize beam clipping. Eqs. 4 and 5 describe the propagation of Gaussian beams in free space

$${z}_{R} = \frac{π {ω}_{0}^{2}}{λ} , \\ {ω}_{z} = {{ω}_{0} [ 1 + {( \frac{z}{{z}_{R}} )}^{2} ]}^{\frac{1}{2}} \qquad Eqs . \text{(4,5)}$$

where ω₀ is the beam waist radius, ω_{z} is the beam radius at a distance z from the waist, λ is the wavelength and Z_{R} is the Raleigh range. The beam radius is the radial distance from the beam's optical path where the intensity has dropped by a factor of 1/e² or 13.5% of the peak value. Eqs. 4 and 5 may be used to illustrate that if the spacing between the beam directing devices is the limiting aperture then the minimum beam size occurs when the apertures are separated by a distance equal to twice the Raleigh range and the waist ω₀ is midway between the two apertures. Thus the path length and beam size are precisely related in the described exemplary switching core.

In addition to minimizing the beam size, an exemplary embodiment of the present invention preferably reduces the insertion loss of the switching core. The insertion loss is typically expressed in dB and may be calculated in accordance with Eq. 6

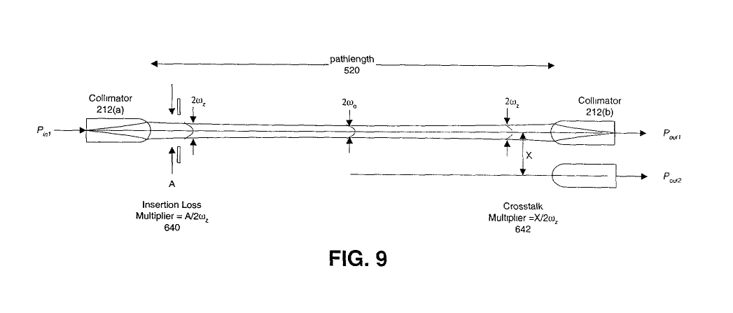

IL=−10log₁₀(Pₒᵤₜ₁/Pᵢₙ₁) Eq. (6)

where Pᵢₙ₁ is the input optical power and Pₒᵤₜ₁ is the output optical power as shown in FIG. 9. Items that contribute to insertion loss include coupling between the collimating optics and imperfect reflections or transmission properties of the various surfaces in the optical path. In the described exemplary embodiment, anti-reflective coatings may be used on the transparent surfaces and noble metal or dielectric stacks may be used on reflecting surfaces to minimize insertion loss.

In addition, the insertion loss of the collimating optics is reduced when symmetric collimating elements are used, i.e. identical collimators face each other and they are separated so that the beam waist is midway between them. As the optical path length deviates from the preferred design, either closer or farther, the insertion loss gradually increases due to modal mismatch as the beam couples into the fiber's waveguide. In this instance the path length used to determine the beam size should not be the shortest path as shown in FIG. 7 but the average path length. In addition, designs using large scan angles may introduce path dependent insertion loss for devices having non-symmetric collimating optics. The path dependent variation in insertion loss may be calculated for the specific geometry of the switch and collimating optics design and may limit the maximum useful scan angle of such a switching core.

Returning to the Gaussian beam analysis, in the described exemplary embodiment, the minimum and maximum paths between input and output ports may be averaged and set equal to twice the Raleigh range. In the described exemplary embodiment illustrated in FIG. 7 the path length may be related to the Raleigh range as given by Eq. 7

2Z_{R}=path length((cos(α)+1)/2) Eq. (7)

Using z=Z_{R} in Eq. 5 to calculate the beam size, 2ω_{z}, yields:

beam size=2ω_{z}=2√2ω₀ Eq. (8)

Equations 4, 7 and 8 may be combined to define the minimum beam size (diameter) in terms of the path length, wavelength and scan angle as provided in Eq. 9.

$$beam size = {[ \frac{2 λ \cdot path l ength}{π} ( cos ( α ) + 1 ) ]}^{1 / 2} \qquad Eq . ( 9 )$$

Eq. 3 on the other hand defines the minimum path length in terms of the port count, unit cell size and scan angle. Therefore, Eqs. 3 and 9 may be combined to define the beam size as a function of the scan angle, unit cell size and port count as provided in Eq. 10.

$$beam size = {[ \frac{2 λ \cdot ( cos ( α ) + 1 ) \cdot {( unit cell \cdot port count )}^{1 / 2}}{{π}^{3 / 2} tan ( α )} ]}^{1 / 2} \qquad Eq . ( 10 )$$

One of skill in the art will appreciate that an optical design that covers a range of wavelengths, such as 1.26 μm to 1.60 μm, may be tuned to operate across the band using computer aided design tools such as, for example Zemax. In general, using beam sizes slightly larger than the Gaussian limit allows for simultaneous solutions for symmetric embodiments at two wavelengths. This can be used for broad bandwidth optical designs. The inter-relationship of the design parameters, however, are given in the above equations and summarized in Eq. 10.

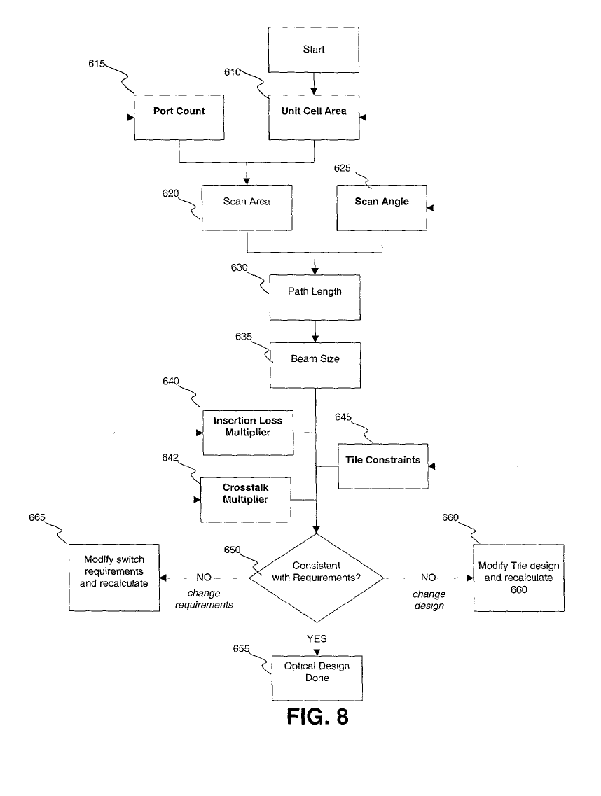

An exemplary process for designing a switching core is graphically illustrated in the flowchart of FIG. 8. In accordance with the described exemplary design process the unit cell area may be input 610 with knowledge of the tile design. In practice the unit cell area may be minimized subject to technology constraints. The desired port count may also be input 615 allowing for the calculation of the required scan area 620 in accordance with Eq. 1. The scan angle 625 of the beam directing devices may also be input and along with the scan area, may be used to calculate the path length 630 as provided in Eq. 3. The minimum Gaussian beam size at the beam directing devices may then be determined 635 in accordance with Eq. 8. At this point an optical design has been specified. However, an exemplary design process may now validate that the specified optical design complies with system performance requirements.

For example, the performance of an optical switch core may be limited by the insertion loss for a channel and the crosstalk between channels. As previously discussed clipping of the beam, particularly near the input may create diffraction that expands the beam as it propagates, resulting in significant clipping and modal mismatch at the output tile. The described exemplary design process may therefore define an insertion loss multiplier 640 that may limit the minimum physical size of the apertures in the transparent beam directing array that the optical beam passes through.

The described exemplary design process may define the insertion loss multiplier as a multiple of the beam size. For example, aperture diameters greater than about twice the beam size (4ω_{z}) have negligible impact on insertion loss while aperture diameters approximately equal to the beam size (2ω_{z}) may introduce insertion losses on the order of 1-2 dB or more. Therefore, in an exemplary embodiment, the insertion loss multiplier may be equal to or greater than the beam size (2ω_{z}) and less than or equal to twice the beam size (4ω_{z}) depending on the insertion loss requirements of the particular application. Thus the insertion loss requirements translate into physical clearance requirements typically in the range of one to two times the beam size.

Crosstalk occurs when the light from one channel is coupled into another channel. Optical crosstalk is usually worst for nearest neighbor channels. Optical crosstalk between channels 1 and 2 may be calculated in accordance with Eq. 11

CT₁₂=−10log₁₀(Pₒᵤₜ₂/Pᵢₙ₁) Eq. (11)

where Pᵢₙ₁ is the optical power input to channel 1 and Pₒᵤₜ₂ is the unintended output optical power coupled into channel 2 as shown in FIG. 9. Crosstalk may be improved by increasing the separation between ports, and a crosstalk multiplier may therefore be expressed as a multiple of the beam size. For example, an illustrative embodiment having a 0.55 mm beam size at the 1.25 mm diameter of the collimating elements and a spacing of 160 mm produced crosstalk of 20, 50 and 70 dB for crosstalk multipliers equal to the beam size, twice the beam size and three times the beam size respectively. The described exemplary crosstalk multiplier 641 translates the beam size 635 and the crosstalk requirements of a particular application into a minimum pitch and therefore limits the unit cell area 225. The described exemplary design process therefore verifies that the starting unit cell complies with the crosstalk multiplier requirements.

If the crosstalk and insertion loss requirements are satisfied, the design is done. If not, either the tile design or its elements may be modified or the switch requirements including the port count, insertion loss or crosstalk requirements may be modified to satisfy the system performance requirements. The described exemplary process illustrated in FIG. 8 is then iterated and checked again for consistency with the insertion loss and crosstalk requirements. The described exemplary design process typically converges on a solution within two or three iterations.

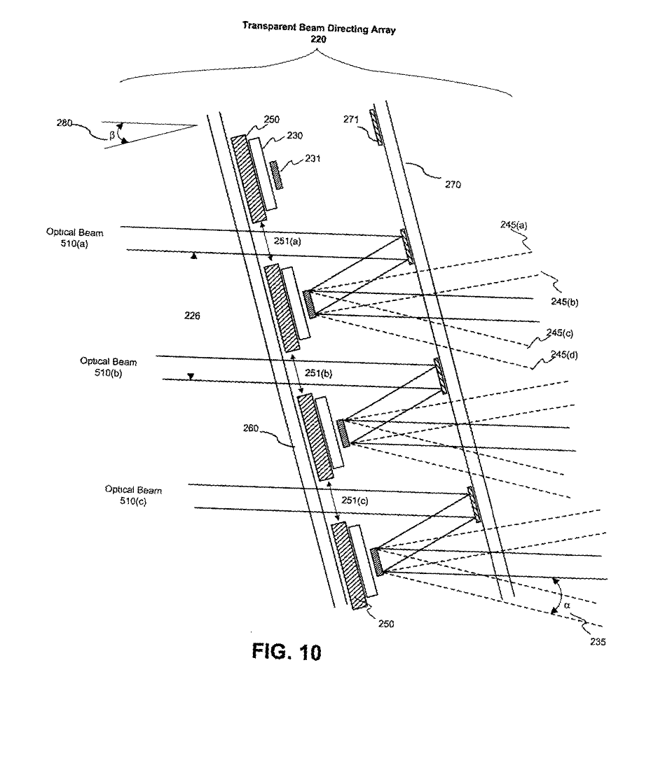

The described exemplary design process may be best illustrated in the context of an exemplary switching core. A cross section of an exemplary transparent beam directing array, 220 is shown in FIG. 10. The described exemplary transparent beam directing array utilizes reflective beam directing device 231 to redirect incoming optical beams. In one embodiment the beam directing devices 231 may be coupled to chips 230 and configured as linear arrays. In the illustrated embodiment the devices are arrayed into the page.

In the described exemplary embodiment the arrays of beam directing devices may be coupled to an opaque substrate 250 comprising holes 251 to allow the optical beams 510 to pass through. The substrate 250 may further include electrical interconnects that provide the connections between the linear beam directing arrays 230 and the drive electronics. The described exemplary transparent beam directing array may also include a lower window 260 and an upper window 270 that seal the package. In an exemplary embodiment the upper and lower windows may include anti-reflective coatings to reduce insertion loss.

In the described exemplary embodiment, strips of high-reflectivity coatings 271 may be disposed on the interior of the upper window 270. In accordance with an exemplary embodiment, the optical beams 510 enter through the lower window 260, pass through the substrate 250 and traverse up to the strips of the high-reflectivity coating 271 where they are reflected back to their associated beam directing device 231. In the relaxed state the exit beams are substantially parallel to the entrance beams and are shifted by the double bounce.

Exit beams 245(a-d) graphically illustrate the redirection of the exit beams through the scan angle 235, α. In the described exemplary embodiment, the insertion loss multiplier may restrict the size of the effective apertures of the transparent beam directing array. In an exemplary embodiment, the beam directing devices 231(a-d) may be kept small to maximize the scan angle and may therefore represent the smallest aperture in the optical beam path. Other apertures traversed by the optical beam include holes 251(a-c) in the substrate 250, the edges of the linear beam directing array 230 and the reflective strips 271 to the extent that they encroach on the beam path 510 in either the relaxed or scanned states. The width of the reflective strips is an aperture on the first bounce while its edges are apertures to the scanned beams.

In accordance with an exemplary design process the size of a particular effective aperture may be determined by taking a projection along the beam path as it traverses the transparent beam directing array 220. In the described exemplary embodiment, the assembly tolerances of the elements and the alignment tolerances of the optical beams may be taken into account in a worst case or statistical insertion loss analysis. In accordance with an exemplary design process the various effective apertures are analyzed to determine if they comply with the described exemplary insertion loss multiplier. Similarly, the described exemplary design process may also analyze the cross-strip pitch and in-strip pitch to determine if they comply with the described exemplary crosstalk multiplier requirements.

If one or more of the effective apertures do not comply with the insertion loss multiplier, the effective aperture can be changed by modifying the cross-strip pitch, beam scanning device diameter, or the cant angle 280, β. Compliance with the crosstalk multiplier may be achieved by increasing the in-strip or cross strip pitch as necessary. The net result is usually a larger unit cell (i.e. the product of the cross-strip pitch 226 and the in-strip pitch of the linear arrays 230). A larger unit cell often may require the design requirement to be relaxed or an improvement in the design (i.e. reduced tolerances etc.). Relaxing the insertion loss or cross talk requirements tends to shrink the unit cell, while lower port count requirements enable the scanning of larger unit cells. Alternatively, higher scan angle beam directing devices or improved transparent beam directing array designs can improve the performance a particular embodiment.

The general optical design process of an exemplary switch core is not limited to the disclosed exemplary design. Rather, many variations will be obvious to those skilled in the art. The optical design of a switch core for a particular application may be conducted in a similar manner, preferably using computer aided design tools. In addition, the present invention is not limited to a particular switch core design. Rather many of the advantages of the described exemplary switch core may be realized in various ways with a multitude of different components. However, the advantages of the present invention may be further demonstrated in the context of exemplary embodiments of the various switch core elements.

Tile

For example, the design of an optical switch core is usually specific for a given port count switch. The point design nature of conventional switch cores typically results from the balancing of active device performance, optical performance, and assembly tolerances. However, the described exemplary tile 200 illustrated in FIG. 2 allows a single switching engine, the tile, to be applied to a wide range of port counts without having to redesign the switching element. The modularity and scalability of the described exemplary tile provides advantages in terms of product development, manufacturing tooling and qualification costs. In the described exemplary embodiment, incoming optical beams are transmitted from the collimating optics 210 through the substrate 250 of the transparent beam directing array 220 and redirected through an opposing window of the transparent beam directing array 220 to any one of a plurality of output ports. The described exemplary tiles may therefore be coupled side by side to form a modular, non-blocking array of beam directing devices with obstacle free optical paths. This is not the case for arrays in single-window packages used in a reflection mode.

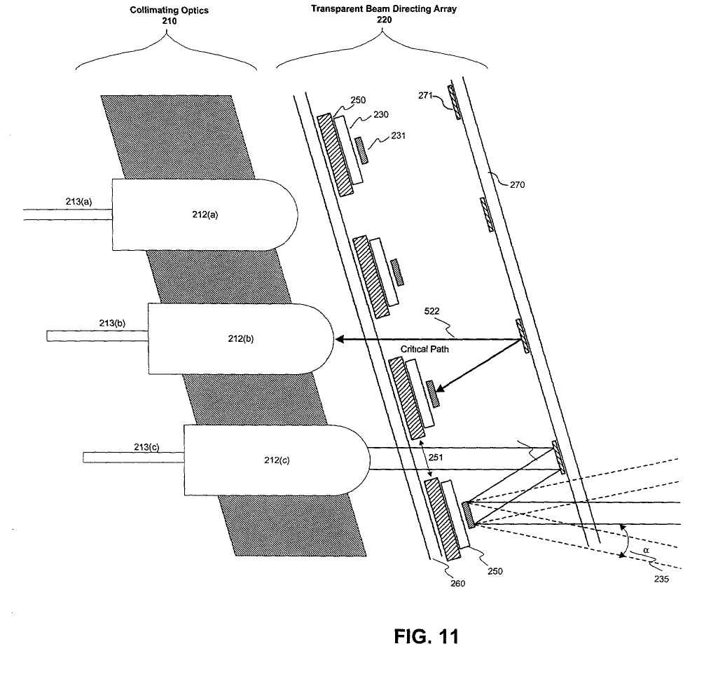

In addition, the described exemplary transparent design makes the path length between input and output fibers as short as possible since most of the path is used for switching between ports. Advantageously, reducing the path length reduces the beam size. Further, in the described exemplary embodiment the collimating optics array 210 is in relative close proximity to the beam directing devices, reducing the sensitivity of the design to the pointing accuracy of the collimating optical elements. For example, referring to FIG. 11 the targeting error associated with the pointing accuracy of the collimating optics is defined as the separation between the optical axis of the incoming optical beam and the center of the beam directing device. The targeting error may therefore be calculated as the product of a critical path 522 (i.e. the path length from the collimating lenses 212 to the beam directing device 231) and the pointing error of the collimating optic.

Therefore the critical path is in effect a lever arm and directly affects the design tolerances of the switch core. Advantageously, the described exemplary transparent beam directing array reduces the critical path 522 as compared to conventional solutions and therefore allows for the utilization of relaxed alignment tolerances between the beam directing array 230 and the collimating lenses 212. The relaxed alignment tolerance directly reduce the manufacturing tolerances of the collimating optics array.

Commonly owned U.S. Pat. No. 6,347,167, entitled “FIBER OPTIC CROSS CONNECT WITH UNIFORM REDIRECTION LENGTH AND FOLDING OF LIGHT BEAMS,” the content of which is hereby incorporated by reference, describes features of an exemplary optical cross-connect with uniform redirection length.

The relaxed manufacturing tolerances enable an exemplary collimating optics array to be formed from a plate with machined, molded or micro-fabricated holes with precision aligned collimating lenses 212 coupled therein. In an exemplary embodiment the collimating lenses 212 may be coupled to a fiber 213 using a camera to ensure that the beam is centered on the mechanical axis at the critical path length from the collimator vertex. The described exemplary passive assembly of the collimating optics array is cost effective and readily implemented with standard manufacturing techniques. However, one of skill in the art will appreciate that the collimating optics array may be actively aligned during assembly.

Independent of alignment technique the lower window 260 may be utilized to seal the transparent beam directing array while allowing incoming optical beams to propagate from the collimating lenses into the transparent beam directing array package. Therefore, in the described exemplary embodiment, the collimating optics array 210 may be fabricated independently from the transparent beam directing array 220. The collimating optics array may then be mated with the transparent beam directing array 220 using passive alignment datums, such as pins, reference edges or the like to optically align the two devices.

One of skill in the art will appreciate that the present invention is not limited to the use of arrays of discrete collimating lenses. Rather, the collimating optics array may also be fabricated from an array(s) of microlenses and array(s) of optical fibers. In each instance however, the modularity and relaxed alignment tolerances of the tile design facilitate lower cost manufacturing using a wide array of applicable manufacturing technologies.

In the exemplary embodiment illustrated in FIG. 11 it is assumed that a convergence lens (not shown) is included in the switch core so that the beams exiting the transparent beam directing device are all parallel and the collimating optics are uniformly arrayed. If a convergence lens is not used the overlap of the scan areas of the individual beam directing devices may be reduced resulting in an inefficient use of the limited tilt angle of the beam directing devices. One of skill in the art will appreciate that uniform arrays are easier to design, manufacture and optimize.

In accordance with an exemplary embodiment the tile of FIG. 11 may be utilized to form a multi-tile array as illustrated in the top view of FIG. 12. The planview includes a limited number of optical elements for clarity of presentation. In the described exemplary embodiment each of the four tiles has a continuous substrate 250 with holes 251 for the optical beams. In this embodiment, each tile further comprises six linear arrays 230, each linear array comprising eight reflective beam directing devices 231. In the described exemplary embodiment, the beam directing devices may be MEMS mirrors with a scan angle α on the order of about five degrees. One of skill in the art will appreciate that many other array configurations are possible, ranging from arrays of single beam directing devices to clusters in linear or two-dimensional formats. However, the use of strips or clusters of beam directing devices provides a variety of distinct advantages. For example, the modularized mirror arrays may be manufactured at a reduced cost as compared to a monolithic mirror array because the manufacturing yield of the smaller tiles is significantly higher than the yield of a single large monolithic mirror chip. In addition, the utilization of clusters or strips of beam directing devices allows the described exemplary tile to be more readily scaled. The beam directing array 230 may be electrically coupled to the substrate 250 by a number of conventional methods, such as, for example, wire bonding. Advantageously, as the port count per tile is increased the described exemplary switch core design does not become bond pad limited, as is the case in monolithic array designs.

For the sake of clarity, the high-reflectivity strips 271 are only shown on the tile in the upper right quadrant. In operation, the high-reflectivity strips reflect the light coming up through the holes 251 in the substrate back down to the beam directing devices 231. In an exemplary embodiment the high-reflectivity strips may be made of metal such as gold on a nickel adhesion layer or a multi-layer dielectric stack.

Referring back to FIG. 11, the substrate 250 and the lower window 260 form the bottom of the package. In one embodiment the transparent beam directing array may be formed as a hermetic package as may be needed to protect sensitive devices such as MEMS from the surrounding environment. In the described exemplary embodiment, high density electrical interconnects may be utilized to electrically couple the beam directing devices to the substrate. However, an exemplary embodiment of the present invention may fan out the electrical traces along the periphery of the substrate of the transparent beam directing array. A lower density interconnect may then be used to interface the described exemplary tile with the drive electronics (not shown) of the beam directing devices.

The substrate may be fabricated in accordance with a variety of techniques to satisfy the demands of a particular application. For example, the substrate may be a ceramic comprising either a multi-layer thick film, a thin film or a hybrid. In this embodiment the interconnects may pass out of the hermetic region as part of the ceramic. In addition, the thermal coefficients of expansion of the various materials used in the hermetic package may be closely matched to reduce thermal induced stresses during operation.

In one embodiment, the lower window 260 may be soldered onto the ceramic substrate and a first seal ring may be soldered on the opposite side. Any of a variety of solders such as a Gold-Tin eutectic or the Indium alloys may be used. However, the Indium alloys have lower soldering temperatures and are more ductile, reducing the stresses that may arise from thermal coefficient of expansion mismatches between the package materials during assembly. In accordance with an exemplary embodiment, the upper window 270 may be separately soldered onto a second matching seal ring. Once the beam directing arrays 230 have been coupled to the substrate 250, the two matching seal rings may be welded together using seam sealing, laser welding or a lower temperature solder as appropriate.

Another transparent beam directing unit may utilize a silicon substrate 250 and a silicon lower window 260. Electrical interconnects may again be formed on the silicon substrate to allow for a lower density interconnection along the periphery of the substrate. In addition, silicon is both transparent for wavelengths greater than 1.1 μm and hermetic. In this embodiment, antireflective coatings such as, for example, a quarter wave of silicon monoxide may be applied to the upper and lower substrate surface at the locations where the incoming optical beams pass through 251. In this embodiment, the upper window 270 and seal rings may also be formed from silicon providing transparent beam directing array with a well matched coefficient of thermal expansion. However, a silicon transparent beam directing array may be relatively brittle.

Returning to FIG. 12, in the described exemplary embodiment each tile has forty four ports within the scan area 530, ensuring forty spec-compliant ports per tile. Therefore, the described exemplary tile may be utilized to form a switch core having a port count that scales and from 40 ports for a single tile to 160 ports for a four tile embodiment. One of skill in the art will appreciate that only the ports within the scan area of the exemplary four tile array need to be interconnected and supported with drive electronics and collimating optics. In the described exemplary embodiment, symmetric tiles are rotated around the optical axis 500 with respect to one other. Further, each tile may be tilted towards the optical axis 500 so that when the beam directing devices are in their relaxed position the redirected beams exiting the transparent beam directing array fall in the center of the output tile array where the optical axis intersects the output address plane. Hence the described exemplary four tile array comprises a pinwheel formed around the optical axis.

The described exemplary embodiment advantageously reduces production part types, tooling and inventory. In another embodiment, common collimating optics arrays are not rotated about the optical axis. In this embodiment the entire array may be located on a flat surface but requires mirrored or flipped substrate layouts to route the interconnects to the periphery away from the optical axis. In addition, an exemplary multi-tile array may be realized with more than four tiles, including using rectangular tiles or wedges. The scaling of the described exemplary array may be further increased by de-populating the more costly components. In practice, the collimating optics, MEMS and drive electronics tend to dominate the manufacturing cost of a typical tile while the design, tooling and qualification of the package dominate the development costs. Therefore, it may be beneficial to partially populate a fully qualified tile with collimating optics and drive electronics to realize a reduced port count switch core.

For example, an illustrative multi-tile array may comprise four symmetric tiles each capable of supporting 256 ports so that the array may scale from 256 to 1024 ports. If only one quarter of the MEMS, collimating optics and drive electronics are loaded during manufacturing, it produces a 64-port tile for little excess cost. One of skill in the art will appreciate that a smaller port count tile design may provide a reduced beam size providing greater assembly tolerances. However, de-populating a higher port count design may be attractive for increasing product offerings while minimizing the production tooling required to support the various switch core products.

FIG. 12 only shows the substrate within the optically active area of the described exemplary tile. FIG. 2 however, illustrates the complete exemplary tile structure with the substrate 250 extending outside the optically active area. Advantageously, in the described exemplary embodiment, the substrate periphery may be extended out as needed to allow interconnection with the drive electronics 230 in accordance with any of a variety of techniques. For example, in one embodiment an exemplary tile may use ribbon cables or connectors as an interface and may not incorporate any drive electronics at all. Further, depending on the scan area 530, not all of the beam directing devices 231 in the array may be addressed in operation. The layout may leave some devices without interconnects and/or optics to save cost and maximize addressable port count as appropriate.

Alternatively, the next level of integration may include drive electronics integrated on a separate substrate such as a printed circuit board with a ribbon or flex cable 240 making the parallel interconnection to the substrate 250 as illustrated in FIG. 2. The described exemplary parallel interconnections can use mature processes such as tape automated bonding, parallel gap welding or high-density connectors. In addition, the use of flex or ribbon connectors may allow the boards to be folded to reduce the size of the switch core. Printed circuit board technology is also very mature and allows the use of available solutions without cost concerns for the real estate used by the chip packages. Such solutions may include for example, digital to analog converters, field programmable gate arrays programmed for pulse width modulation, discrete or integrated amplifiers and the like.

In the described exemplary embodiment the drive electronics 230 may utilize a serial bus to interface with the switch control electronics. The serial interface reduces the complexity of the electrical interconnect between the drive electronics and the control electronics. In addition, the separate electronics and transparent beam directing array substrates may be independently burned-in and tested, improving manufacturing yield and reducing cost.

Another embodiment may utilize a higher level of electronics by integrating the drive electronics onto the substrate 250. This embodiment avoids routing signals off of the substrate and provides a simple serial bus interface between the integrated drive electronics and switch control electronics. This embodiment reduces the electrical input/output count but uses the more expensive substrate material for the electronics. This embodiment may therefore be particularly desirable when the drive electronics have been integrated to several chip sets that use little real estate on the substrate.

Another embodiment may utilize the highest level of integration wherein the drive electronics are incorporated within the beam directing array chips thereby dramatically reducing the number of interconnects. This embodiment simplifies the packaging of the array but also places high demand on the integration of the beam directing devices and semiconductor transistor technology.

Once a tile has been designed and fabricated, multiples of that tile may be coupled to a frame in accordance with the desired port count of a particular application. FIG. 3 shows an exemplary tile array comprising four identical tiles in the address plane 500. In the described exemplary embodiment the windows are not touching in the center by the optical axis 500 but are separated to allow physical packaging. The use of the beam combiner as previously described with respect to FIG. 5 conserves the scan angle by making the ports appear optically adjacent as in the layout of FIG. 12.

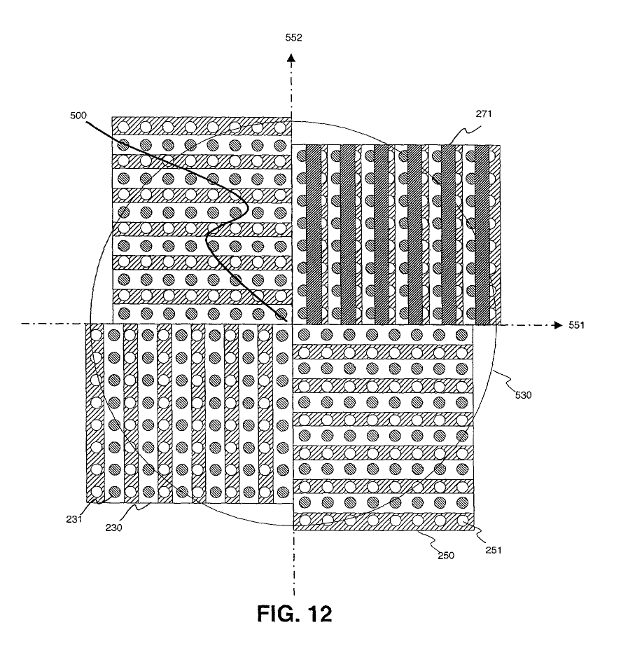

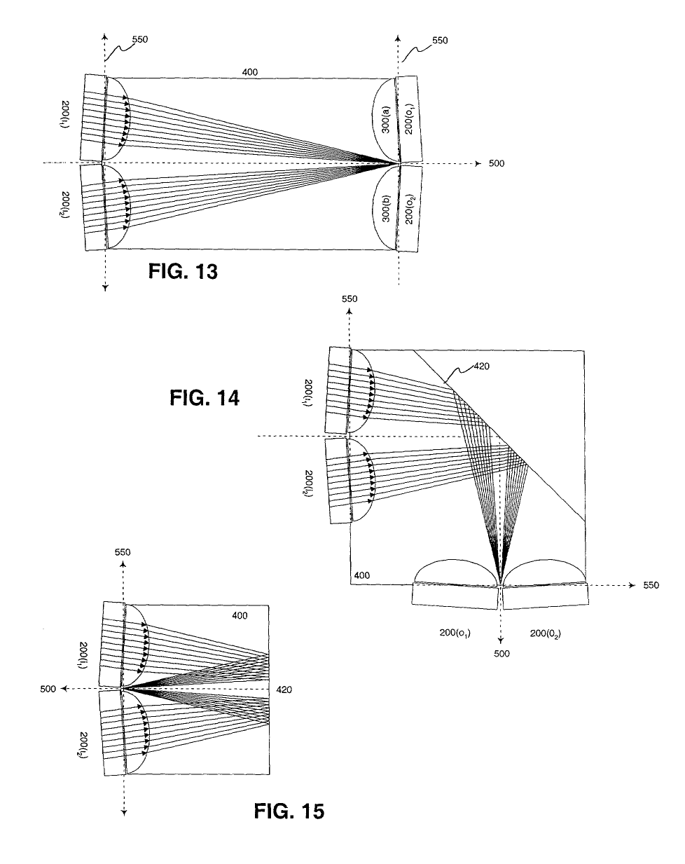

Referring to FIG. 13, in the described exemplary embodiment input and output tiles 200(i₁-i₂) and 200(o₁-o₂) respectively, may be integrated on opposite sides of the frame in the address planes 550. The optical beams are shown in the relaxed position, and the use of a beam combiner has been omitted for simplicity. In the illustrated embodiment each tile includes a convergence lens to increase the overlap of the beam scan areas.

However, the present invention is not limited to switch cores having tiles integrated on opposites of the switching frame. Rather, a reflector 420 may be incorporated into the frame 400 as illustrated in FIG. 14 and FIG. 15 to provide switch cores having tiles that are co-located on the same side of the frame or any where in between. For example, FIG. 14 shows an embodiment having perpendicular input and output tiles 200(i₁-i₂) and 200(o₁-o₂), respectively with a 45° reflector that can be useful for reducing the size of the switch. FIG. 15 shows another embodiment having a retro-reflector that allows the input tiles to address themselves, so that the input and output address planes are coincident. This embodiment may be particularly useful, for example, for fan out applications where only a few ports need to be able to address many ports. One of skill in the art will appreciate that numerous other variations of the frame are possible, including the use of other intervening optics and reflector configurations.

The described exemplary switch core provides advantages beyond modularity for scaling. For example, the described exemplary switch core may provide a physically manageable electrical interconnect and may reduce the package to a more manageable size. For example, as the port count requirements grow beyond the physical limitations of a single tile, multiple transparent beam directing arrays may be integrated on a single tile substrate to scale the tile approach. In this embodiment the electrical interconnects may be routed to the periphery of the tile on the common substrate. Using multiple beam directing arrays on the other hand allows the size of the beam directing array to be matched to physical limitations such as differences in the thermal coefficient of expansion of the various materials used to fabricated the beam directing arrays.

In addition, a variety of optical schemes may be integrated into the described exemplary switch core. For example, a single large convergence lens may be integrated in the optical path above multiple beam directing arrays each of which may have uniform collimating beam angles. Alternatively, a smaller convergence lens may be integrated above each individual beam directing array as illustrated for example in FIG. 13. In this embodiment the angle of the collimating optics array associated may be different for each of the beam directing arrays in the switch core. Similarly, the integration of a beam combiner may be extended if necessary by changing the angle of the beam shifters above each package to avoid optical dead zones on the substrate between the packages.

The present invention provides a modular method for producing an optical switch core that may be scaled over a wide range of port counts simply by adding tiles. In an exemplary embodiment of the present invention the elements of the tile may use standardized interfaces that align the optical arrays and provide for electrical control.

Lens

An optical switch core uses beam directing devices to redirect incoming optical beams to any one of a plurality of output ports. The beam directing devices typically deflect the beam over a scan angle. Often the scan angle is a limiting factor in the port count capability of an optical switch core. In that case it is desirable to have all the beams converge in their relaxed state towards the center of the output port array. The overlap of the scan areas and the corresponding number of addressable ports may be maximized by having the beams converge to a common point at the center of the output array. In practice, a unique compound angle may be presented to each of the beams on the beam axis relative to the other beams to converge the scan centroids to a common point.

One of skill in the art will appreciate that there are many ways to achieve the compound angles for beam convergence. For example, each of the collimating optical elements within the collimating array may be integrated at a unique compound angle relative to each of the other collimating optical elements. However, in this embodiment all the optics have to be aligned to a unique angle. In practice, if holes and discrete collimating lenses are used, this implies a multi-axis machining to very tight tolerances is required to form the co9llimating optics array. If microlens arrays are used, the position of each fiber or its angle has to be different and tightly controlled. In addition, in this embodiment the spacing for the transparent beam directing array changes for each unit cell, further complicating the design and manufacture thereof. It may therefore be advantageous to use uniform optics arrays having uniform unit cell areas.

Alternatively, the compound angle may be introduced optically by either reflection or refraction. For example, referring to FIG. 11, in an exemplary embodiment the high reflectivity strips 271 may be molded with unique compound angles. This allows for the use of uniform collimating optics angles but still results in varying unit cell design.

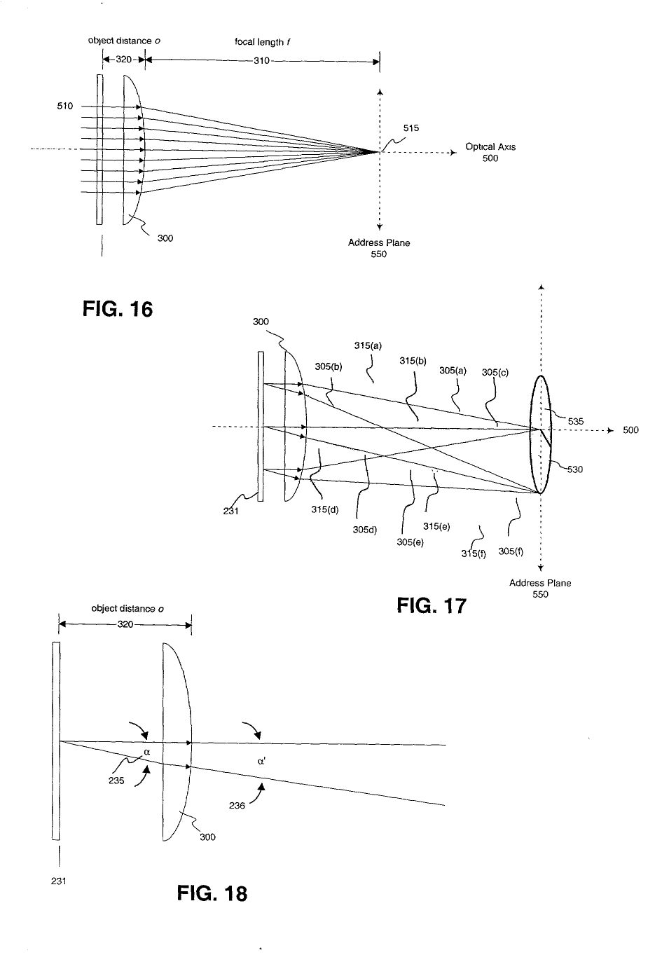

The convergence lens shown in FIG. 16 on the other hand provides the compound angles using the refraction of the lens surface. Lens fabrication technology is relatively mature and inexpensive. For example, the exemplary plano-convex lens shown in FIG. 16 is widely available. One of skill in the art will appreciate that the described exemplary convergence lens is not limited to transparent beam switching arrays. Rather the described exemplary convergence lens may be integrated into any multi-port optical switch to increase the port count of that switch or simplify its design.

The described exemplary convergence lens may be designed to have a focal length 310 that is approximately equal to the distance from the lens to the address plane 550 along the optical axis 500. In an exemplary embodiment the optical axis of the lens 300 may be coincident with the optical axis 500 of the switch core.

The performance of the described exemplary convergence lens is schematically illustrated in FIG. 17. Several beam directing devices across the illustrated array are shown performing scans. For purposes of illustration, the optical paths 305(a-f) and scan areas 530 of beams refracted by the described exemplary convergence lens 300 as well as the optical paths 315(a-f) and scan areas 535 of redirected beams in the absence of the convergence lens 300 are shown. Only the ports in the targeted address plane 550 that fall within the intersection of the scan areas can be addressed. In the absence of the convergence lens the overlap area 535 is a relatively small ellipse. The refractive power of the convergence lens on the other hand shifts the centroid of each of the scan areas to a common point so that the scan areas overlap in the targeted address plane. This maximizes the number of ports that can be addressed.

In accordance with an exemplary embodiment the same convergence lens may be used on the output tiles to ensure the output beam directing devices have sufficient scan angle to redirect the beams into the output fibers. The described exemplary convergence lens may be utilized with a reflective beam directing array having parallel arrays of incident collimated beams. However, in this instance the focal length may need to be increased to take into account the two passes of the beam through the lens. However, the benefits of reduced scan angle and increased number of addressable ports provided by the convergence lens remain the same.

One of skill in the art will appreciate that the described exemplary convergence lens need not converge the refracted beams to a single common point. Rather, an exemplary lens may be utilized to simply shift the refracted beams toward a common point, thereby increasing the overlap of the individual scan areas and the corresponding number of addressable ports.

The performance of the convergence lens is dependent on its proximity to the beam directing devices. The standard lens equation is given in Eq. 10.

1/i+1/o=1/f Eq.(10)

where i is the image distance from the lens, o is the object distance from the lens and f is the focal length. In practice, if a convergence lens is located midway between the beam directing devices and the targeted address plane with a focal length equal to one fourth of the distance separating the beam directing devices and the address plane, the beams converge. In this instance the lens images the input array onto the output array so that the effective scan angles would be zero. Further, a convergence lens 300 having a focal length equal to the distance separating the lens and address plane and a image located at the address plane requires 1/o to be zero, i.e. the object is at infinity. This corresponds to a collimating lens as seen from the address plane that converges incoming parallel beams at the address plane as desired.

Further, when the object distance is small (i.e. close to the convergence lens) a small negative image is formed, implying that the image is on the beam directing array side of the lens and close to the lens. The creation of a negative image reduces the effective scan angle as illustrated in FIG. 18. In this instance the beam scan angle α 235 is reduced to a smaller effective scan angle α′ 236 according to Eq. 11.

α′=α(1−o/f) Eq. (11)

Keeping the lens close to the beam directing devices lessens the reduction in effective scan angle. In an exemplary embodiment a convergence lens may be optically coupled to the upper window 270 of the transparent beam directing array as illustrated in FIG. 10. In an exemplary embodiment of the optical switch core the separation between address planes and hence the focal length of the convergence lens is on the order of about 180 mm while the object distance from the lens is 5 mm. The reduction in scan angle for this example is less than 3%. Therefore, the benefit provided by the described exemplary convergence lens, i.e. increasing the scan angle overlap and the corresponding number of addressable ports, likely outweighs the reduction in scan angle that results from the use of the lens. An exemplary optical design process may therefore utilize the effective scan angle α′ in the optical analysis of the switch discussed earlier.

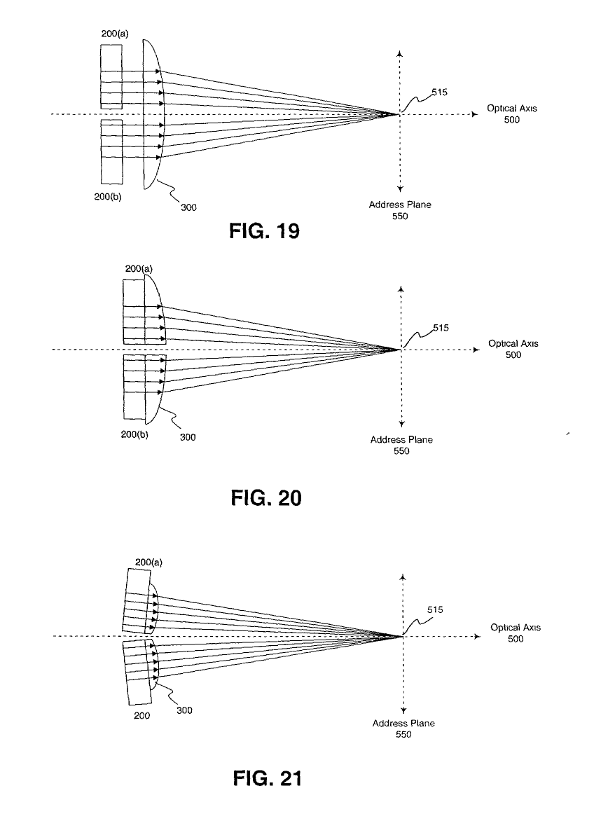

One of skill in the art will appreciate that there are a variety of ways to integrate a convergence lens into an optical switch core. For example, a convergence lens may be integrated over a single array of beam directing devices as illustrated in FIG. 16. Alternatively, a single convergence lens may be integrated above two or more separate and distinct beam directing arrays as illustrated in FIG. 19. Similarly, FIG. 20 shows an exemplary convergence lens coupled to each beam directing array, with the lens effectively cut into pieces matching the spacing between the separate beam directing arrays. This embodiment has the advantage of shorter object distances and improved effective scan angles.

FIG. 21 shows an exemplary embodiment having a separate convergence lens coupled to each beam directing array. In this embodiment the optical axis of each of the convergence lenses may be aligned with the optical axis of the beam directing array. Each beam directing array 200 may then be tilted so that the optical axis of each of the beam directing arrays converges at the intersection of the optical axis of the switch 500 and the targeted address plane 550, producing a common relaxed position 515. In this embodiment the beam redirection is reduced, requiring less refractive power of the lens and thereby reducing chromatic dispersion effects. While dispersion of glass is minimal in the telecommunication wavelengths, broadband designs and alternate lens materials such as silicon can benefit from this configuration.

One of skill in the art will appreciate that the described exemplary convergence lens may be used to increase the scan angle and provide uniform unit cells in both transparent beam directing arrays and reflection mode beam directing arrays. The arrays may be monolithic or broken into clusters or even distinct beam directing devices as illustrated in FIGS. 16, 19, 20 and 21. Therefore the described exemplary embodiments are by way of example only and not by way of limitation.

In an exemplary optical design process the design of the collimating optics may be modified to account for the power of the convergence lens. The waist location and size of Gaussian beams as they propagate through lenses is given by the ABCD formalism. This has been disclosed in “Gaussian beam ray-equivalent modeling and optical design” by Robert Herloski et al in Applied Optics vol. 22, No 8, 15 April 1983 the content of which is incorporated herein by reference. In accordance with an exemplary process the mode field diameter of the fiber as a function of wavelength may be propagated to the collimating optics lens, then through the transparent tile, then through the convergence lens and with the collimating lens designed to place a beam waist of an appropriate size at the center of the switch core.

In addition an exemplary optical design process may also account for the optical power associated with the beam directing devices. For example the optical power associated with curved reflective devices as well as the tolerance of the various optical elements may be included in an exemplary optical design process. In the case of applying the convergence lens to reflective arrays, the lens has an added benefit that the beam is refocused after two passes through the array. This can be used to reduce the spot size requirements at the collimating optics.

An exemplary convergence lens has been described. When placed close to the beam directing devices, the described exemplary convergence lens increases the number of ports the array can address when coupled with parallel beam collimating optics. In operation, the convergence lens shifts the centroid of the scan area of each of the beam directing devices towards the intersection point of the switch core's optical axis and the targeted address plane.

Beam Combiner

There are a number of methods for creating high port count non-blocking optical switches. For example, a high port count optical switch may be realized by simply increasing the number of ports or cascading networks of switches together. However, cascaded switches also cascade the insertion loss of each switch and the coupling in and out of fibers for each stage. Therefore, insertion loss may act to limit the port count that may be realized in a cascaded switch design. Similarly, designs that simply increase the number of ports may run into physical limitations that limit the maximum achievable port count. Typical physical limitations may include, for example, the routing of electrical interconnects into the beam directing array and the reliability restrictions on larger and larger packages.

The use of tiles or clusters of beam directing arrays in an exemplary switch core may therefore be advantageous in high port count optical switches. To be distinct arrays, the clusters of beam directing devices or tiles have space between them to allow package walls, seals, interconnect routings and the like. This space is a region without ports as in the boundaries between the tiles in FIG. 3.

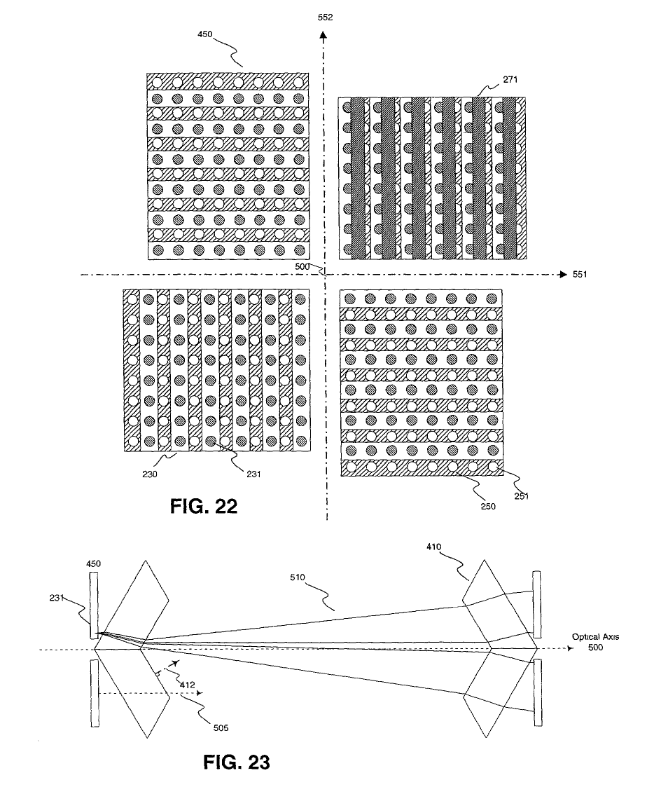

For example, FIG. 22 is a top view of the optical schematic of an exemplary transparent beam directing array. Each cluster or beam directing array 450 within the switch core is separated from the others by the physical constraints of the packages. Compared with FIG. 12, it is clear that the scan area 530 needs to be increased or the port count reduced to account for the space between beam directing arrays. Therefore, it would be advantageous to separate the clusters or beam directing arrays without having to increase the scan area of the beam directing devices to account for the increased spacing.

Therefore, an exemplary embodiment of the present invention may integrate parallel plates at an angle relative to the optical axis to shift the scan area over the clusters as shown in FIG. 23. In the described exemplary embodiment optical beams 510 exiting a beam directing device 231 are incident upon the output beam directing units but are shifted as the scan crosses the vertex of the beam combiner 410. In the described exemplary embodiment the normal of each parallel plate 412 is tilted towards the optical axis 500 of the switch core in the common plane of the switch core axis 500 and tile axis 505.

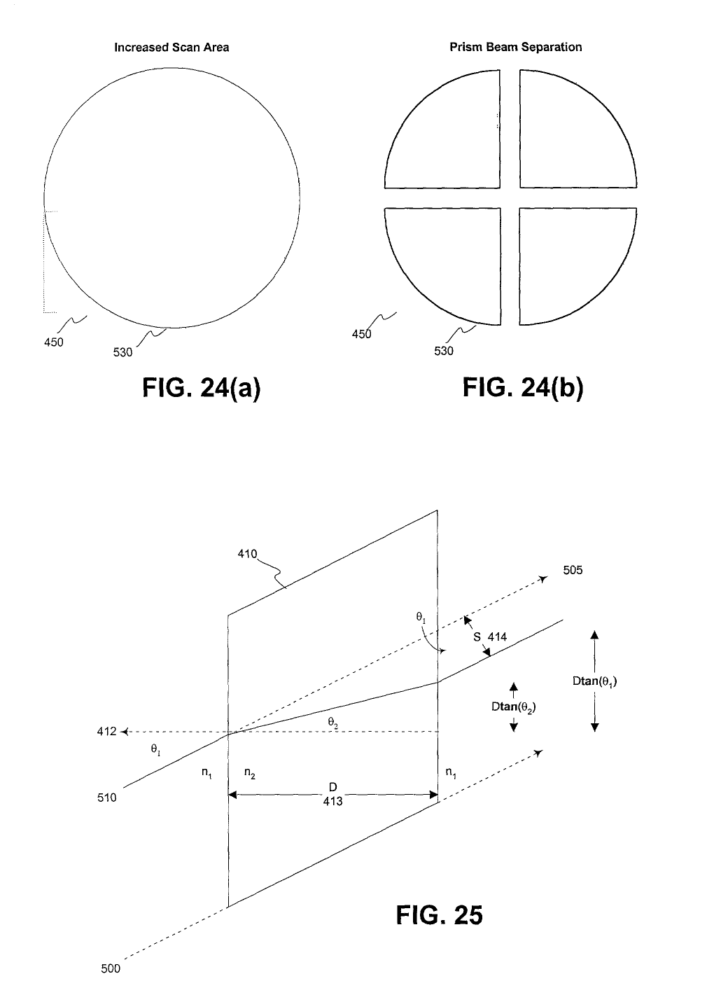

FIG. 24 is a top view illustrating the performance of an exemplary four-tile array. Relative to FIG. 12, FIG. 24a shows the increased scan area needed to address all the ports while FIG. 24b shows the same scan area as in FIG. 12 but shifted by an exemplary four-plate beam combiner whose joints lie above the space between the clusters of beam directing arrays. In operation, the described exemplary parallel plates do not change the angle of the beam. Rather the parallel plates merely shift the position of the beam to compensate for the lost space between beam directing arrays.

The fabrication and integration of the described exemplary parallel plates is relatively straightforward. In fact the joints of the beam combiner need not be joined because beams do not cross the joint boundary. In accordance with an exemplary embodiment the frame may hold the parallel plates with their inner vertexes in close proximity. Whether in pieces or joined together, each surface of the described exemplary beam combiner may include an antireflective coating to minimize the insertion loss. This coating can be done on the sides of the plate in the optical path prior to dicing. In addition, if required the antireflective coatings may be tailored to minimize the polarization dependent loss (PDL) as is known in the art.

FIG. 25 further illustrates the operation of an exemplary parallel plate beam combiner. In the described exemplary embodiment a parallel plate 410 of thickness D 413 is integrated at an angle with respect to the optical axis 500 of the switch core. An optical beam 510 exiting a beam directing array (not shown) is refracted as it enters the higher index material, shifting it away from the optical axis 505 of the tile or beam directing array and towards the optical axis 500 of the switch core. Upon exiting the plate the beam is parallel to its original course but shifted a distance S 414. Snell's law provides the inter-relationship between the angles inside and outside the plate:

n₁ sin(θ₁)=n₂ sin(θ₂) Eq. (11)

where n₁ is the index of refraction in the switch core medium, n₂ is the index of refraction in the plate, θ₁ is the angle of the plate normal 412 with respect to the tile optical axis 505, and θ₂ is the angle of the beam inside the plate with respect to the normal. Therefore, Snell's law may be used to determine the angle inside of an exemplary parallel plate. In addition, the distance that a parallel plate shifts an incoming beam may be calculated according to Eq. 12.

S=D[tan(θ₁)−tan(θ₂)]cos(θ₁) Eq. (12)

where S is the distance that an incoming beam is shifted by the parallel plate and D is the thickness of the plate. Eqs. 11 and 12 may be combined to show that the shift S scales linearly with the thickness of the plate D as illustrated in Eq. 13.

S/D=[tan(θ₁)−1/{[n₂/(n₁ sin(θ₁))]²−1}^{½}]cos(θ₁) Eq. (13)

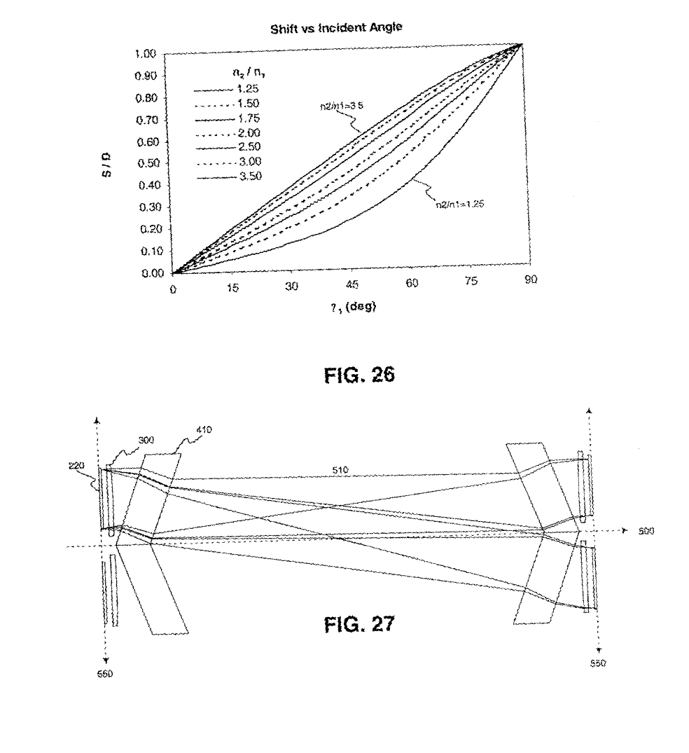

FIG. 26 graphically illustrates the ratio of the distance an incoming beam is shifted divided by the plate thickness as a function of the incident angle, θ₁, for various ratios of the indices of refraction of the beam combiner and the medium of the switch core (i.e. n₂/n₁). In practice larger incident angles and larger index ratios produce larger shifts in the position of an incoming optical beam up to the maximum deflection, which is equal to the thickness of the plate. Generally, the shift distance for different wavelengths is a minimum for glass in the telecommunication wavelengths and generally increases for high index materials wherein the index ratio increase vertically in FIG. 26 from a ratio of 1.25 to a ration of 3.5. Therefore, the thickness and material of an exemplary beam combiner may be selected to satisfy the particular shift requirements and optical specifications of a particular application.

One of skill in the art will appreciate that the described exemplary beam combiner is not limited to parallel plate beam shifters. Rather non-parallel plate beam combiners may be used to compensate for the separation of beam directing arrays in an optical switch core. However, the described exemplary parallel plate beam combiner has minimal chromatic dispersion. Although the distance that a given incoming optical beam is shifted S varies slightly with wavelength due to the wavelength dependence of the refractive index, the entrance and exit angles will be substantially the same. If a non-parallel beam combiner were used, any angular difference in the plate is multiplied by the path length to create much larger wavelength dependent losses when multiple wavelengths are traveling down the same optical path. As an example, SFL6 glass has an index of 1.7675 at a wavelength of 1.3 μm and 1.7619 at a wavelength of 1.6 μm. Using Eq. 13, a 15 mm thick plate produces a shift of 3.66 mm with a separation of 13 μm between a 1.3 μm and 1.6 μm wavelength. If a solid glass beam combiner were used between input and output address planes the chromatic separation of beams could be more than ten times greater than this number.

FIG. 27 is a schematic cross section of an exemplary four-tile design with beams being scanned by the beam directing devices to address the output ports. The optical beams 510 are propagated from the beam directing array 220 through the convergence lens 300 and the beam combiner 410 and then enter the output array with an identical configuration. In the described exemplary embodiment the beams do not cross the joints between the plates. This places a constraint on the design of a beam combiner to avoid clipping the scanned beams. The constraint is minimized for thinner plates and lower incident angles. In addition, integrating an exemplary beam combiner closer to the beam directing array also reduces the “clipping” effect that the joints of the beam combiner may have on optical beams. Therefore, an exemplary beam combiner may be designed to balance the plate thickness, the incident angle and index ratio to achieve the desired beam shift with acceptable chromatic dispersion, polarization dependent loss and port count.

The optical design of a convergence lens used in conjunction with a beam combiner in an exemplary switch core preferably accounts for the effect of the beam combiner. For example, if the exemplary lens configuration illustrated in FIG. 21 is used, only the change in effective optical path length needs to be taken into account when the lens configuration is designed. If the exemplary lens configuration illustrated in FIG. 20 is used in conjunction with a beam combiner the lens may be cut and separated so that the edges fall on the separate images. The exemplary lens configuration of FIG. 19 is non-ideal for use across the vertex of a beam combiner, although compromised designs can be created.

In operation the described exemplary beam combiner combines the beams from spatially independent beam directing arrays each having a plurality of beam directing devices so that the beam directing arrays appear to be optically adjacent to each other. One of skill in the art will appreciate that the present invention is not limited to a particular beam directing array. Rather the described exemplary embodiment may be utilized to compensate for the spatial separation of any beam directing array.

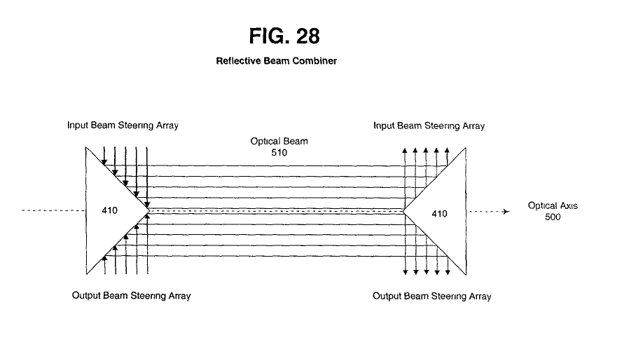

One of skill in the art will further appreciate that the present invention is not limited to transparent parallel plate beam combiners. Rather the described exemplary beam combiner may be formed from faceted reflectors. For example, FIG. 28 shows a reflective beam combiner 410 that may be used to combine and then separate the beams to different tiles. In this embodiment the input and output beam directing arrays are no longer in a common plane providing additional space around the arrays for attachment, seals etc. In addition, the reflective beam combiner has zero chromatic dispersion because refraction is not used. In accordance with an exemplary embodiment the oblique angles of the facets may be designed to ensure that the high reflectivity surfaces do not induce significant polarization dependent loss. In addition, if required due to the well known polarization dependent loss of metal reflectors at oblique angles the reflective beam combiner may be formed from a dielectric stack rather than a metal reflector.

In practice when a reflective beam combiner is used in conjunction with reflective beam directing arrays the oblique angles of the facets of the beam combiner may limit the available optical configurations of the switch core. Similar attention must be made to clipping at the facet joints as in the case of the transparent beam combiner of FIG. 23.

A beam combiner has been disclosed that may be utilized in combination with two or more physical separate beam directing arrays, each comprising a plurality of beam directing devices, without increasing the required scan area and corresponding scan angle. In accordance with an exemplary embodiment the beam directing arrays appear to be adjacent to one another when optically observed through the beam combiner. The benefits derived from the described exemplary beam combiner are applicable to both transparent beam directing arrays and reflective beam directing arrays. In operation the described exemplary beam combiner allows the physical separation of beam directing arrays while conserving the scan area required to address the ports. As shown in FIG. 8 reduced scan area results in smaller beam sizes yielding improved insertion loss and cross talk for a given port count.

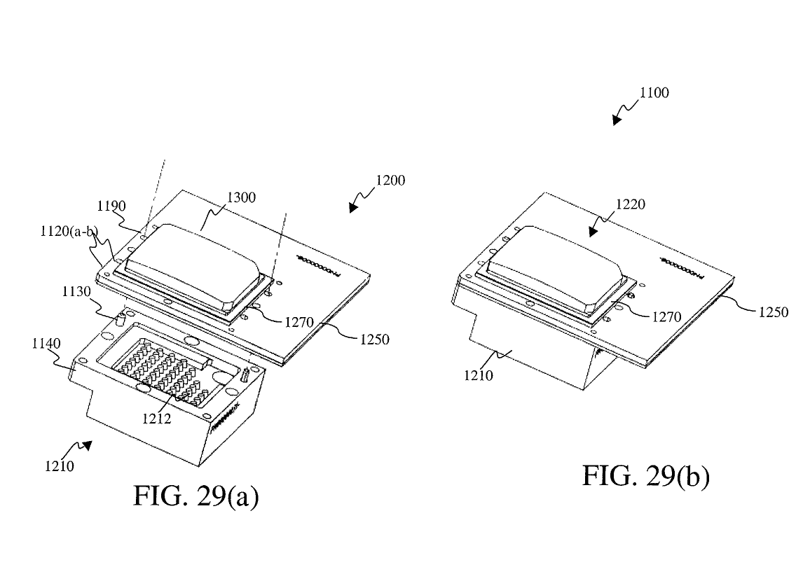

The advantages of the present invention may be further demonstrated in the context of an exemplary embodiment of the optical switch core. A perspective view of an exemplary tile 1200 is shown in FIGS. 29(a) and (b). FIG. 29(b) shows the described exemplary transparent beam directing array 1220 mated with the collimating optics array 1210. In the described exemplary embodiment a convergence lens 1300 has been coupled to the upper window 1270 of the transparent beam directing array. In accordance with an exemplary embodiment the tile 1200 may comprise precision mounting holes, 1120(a) and (b) for example, which may be used to couple the tile to the frame (not shown). FIG. 29(a) shows an exploded view of the described exemplary tile with the transparent beam directing array 1220 separated from the collimating optics array 1210.

In accordance with an exemplary embodiment, the collimating optics array may comprise a collimating optics plate 1140 comprising precision alignment pins 1130 that may be utilize to mate with precision alignment holes 1190 on the tile to ensure that the transparent beam directing array and the collimating optics array are coupled to a common reference. The exploded view further illustrates the individual collimator lenses 1212 coupled to the collimator plate 1140.

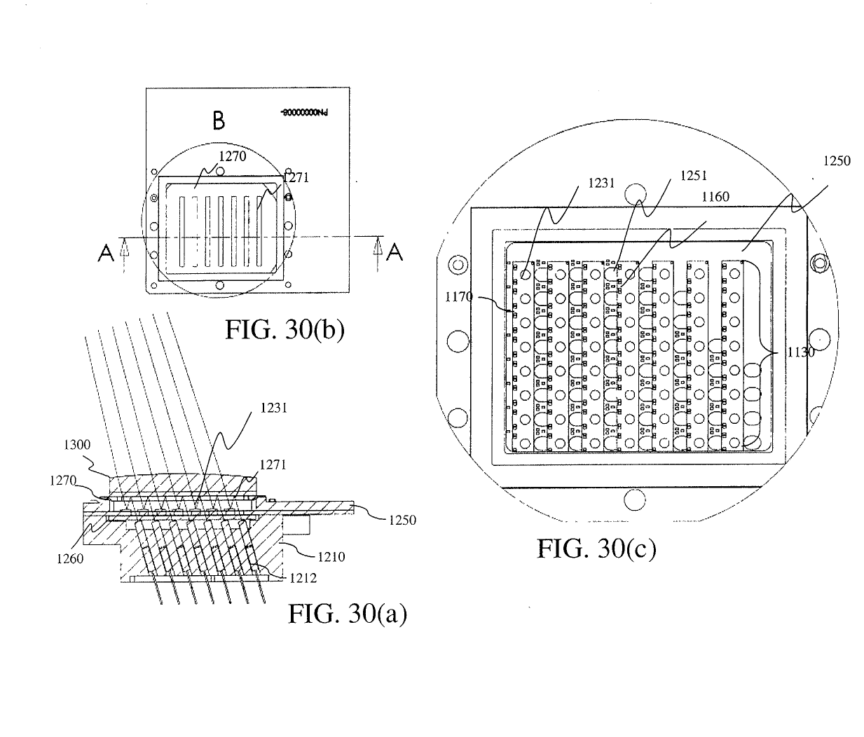

FIG. 30(a) is a cross sectional view of the described exemplary tile having the collimating optics array 1210 coupled to the transparent beam directing array 1220. The cross sectional view further illustrates the path of the optical beams traveling from the collimating lens 1212, through the lower window 1260 and substrate 1250, reflecting off the high-reflectivity strips 1271, reflecting off the MEMS beam directing devices 1231 and out the upper window 1260 and convergence lens 1300. FIG. 30(b) is a planview of the underside of the upper window 1260 illustrating the integration of the high reflectivity strips 1271 the underside of the upper window 1260. FIG. 30(c) shows a top view of the tile with the lid removed. In the described exemplary embodiment the MEMS mirror 1231 may be formed into strip arrays 1130. In addition, the bond pads 1160 of the MEMs mirrors 1231 may be interdigitated with arrays of vias 1251 formed in the substrate 1250 with substrate bond pads 1170 that may be routed out onto the substrate to form a lower density interconnect (not shown). In the described exemplary embodiment the precision alignment holes 1190 may be pre-made in a metal spacer that has been soldered to the substrate.

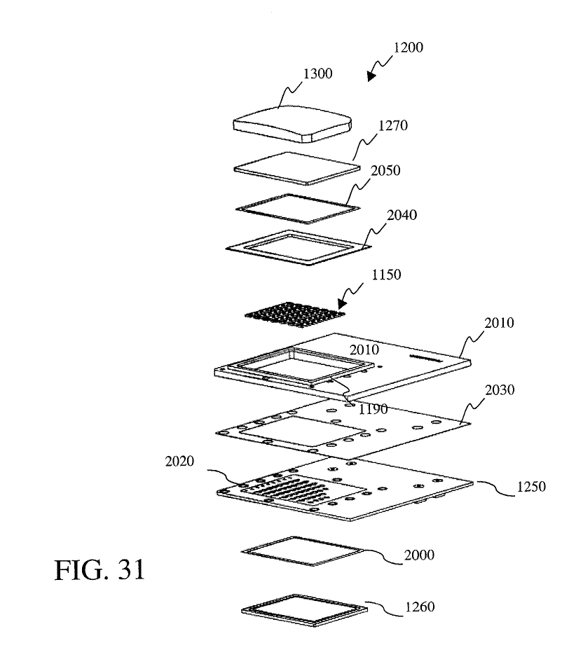

FIG. 31 shows an exploded view of the described exemplary optical tile 1200. In accordance with an exemplary embodiment the transparent beam directing array 1220 forms a hermetically sealed environment as may be desirable for reliable operation of many MEMS devices. In the described exemplary embodiment the transparent surfaces, i.e. upper and lower windows 1270 and 1260 respectively, may include an optical antireflective coating. In accordance with an exemplary embodiment the antireflective coatings may be designed in accordance with the specific switching application, the system bandwidth and other performance requirements.

In accordance with an exemplary embodiment, the optical bandwidth may range from about 1.26 μm to 1.62 μm and the beam has a nominal cant angle of 16° with respect to the normal (see optical path in Figure PB(a)). The utilization of a slanted optical path ensures that the tile will have minimal optical back-reflection. In the described exemplary embodiment the lower window 1260 may have a Cr/Ni/Au seal frame 2000 evaporated on its periphery to form a solder bonding surface. In the described exemplary embodiment the lower window 1260 has antireflective coating deposited on both the upper and lower optical surfaces using conventional methods.

In the described exemplary embodiment the substrate 1250 is a multi-layer ceramic substrate such as low temperature co-fired ceramic. One of skill in the art will appreciate however that any other ceramic substrate technology that is multi-layer and hermetic capable such as high-temperature co-fired ceramic, thick film or thin film may also be used. In the described exemplary embodiment the substrate routes electrical connections into the hermetic environment and provides mechanical rigidity and dimensional stability.

In an exemplary embodiment a spacer 2010 may be utilized to form a cavity in the transparent beam directing array. The spacer preferably includes the precision alignment holes 1190, which overlay with oversized holes 2020 in the substrate. In the described exemplary embodiment the spacer 2010 may be formed from kovar to provide a good thermal coefficient of expansion (CTE) match to the ceramic substrate and glass windows. In the described exemplary embodiment the CTEs of all materials in the optical tile that experience high temperatures are preferably closely matched. In accordance with an exemplary embodiment the spacer may be plated with Ni/Au to provide a solder compatible surface.

The lower window 1260 and spacer may be soldered to the substrate 1250 in a single step using the solder preforms 2000 and 2030 respectively. In the described exemplary embodiment the soldering is done in an inert environment to prevent contamination of the optical surfaces with flux and wash processes. Indium containing solders are may be used to reduce the solder temperature and for a more ductile bond. At this point the lower half of the package is formed.

In accordance with an exemplary embodiment the upper window 1270 may be soldered to a similarly prepared kovar lid 2040 using a solder preform 2050. In the described exemplary embodiment the assembled lid and lower window and the substrate assembly may be checked for hermeticity using an open-lid leak check as is known in the art. The MEMS mirror arrays 1150 may then be die attached to the substrate 1250 using a UV sensitive epoxy and an alignment jig. The UV sensitive epoxy preferably has low out-gassing and is capable of a thermal cure. Depending on the temperature limitations of the MEMS devices, many other conventional die attach methods may be used.

In the described exemplary embodiment the MEMS mirror arrays 1130 are formed on MEMs chips that may be diced to precision with respect to the centers of the beam directing devices. In the described exemplary embodiment the alignment jig references the spacer precision alignment holes 1190 to locate datums that may be used to locate the chip on the substrate. The described exemplary datums therefore reference the mirror arrays collimating optics array to a common point. Commonly owned, co-pending U.S. patent application Ser. No. 09/896,012, entitled “APPARATUS AND METHOD FOR ALIGNMENT AND ASSEMBLY OF MICRO-DEVICES”, filed Jun. 28, 2001 the content of which is hereby incorporated by reference, discloses an exemplary method for passively assembling the MEMs mirrors.

The described exemplary technique reduces tolerance stackups and can place the arrays within about 10 μm of their desired location. Once the MEMs chips are placed in the correct location they may be checked for planarity and placement, then tacked into place with a UV light source. The MEMs chips may then be cured using a temperature in the range of about 80-100° C. The MEMS arrays are then bonded to the substrate using wire bonds. Both wedge and ball bonding can be used.

The two halves of the transparent beam directing array are now completed and are ready for final seal. In accordance with an exemplary embodiment the lid may be coupled to the substrate using the precision alignment holes 1190 in the spacer 2010 and tacked into place in a couple of places. The entire assembly may then be baked out under vacuum and elevated temperatures for an extended period to drive out any moisture that may be in the transparent beam directing array. In accordance with an exemplary embodiment the transparent beam directing array may then be passed into a controlled dry and inert environment containing dry Nitrogen and a small fraction of Helium as a leak tracer. In the described exemplary embodiment the lid is resistance welded into place. This creates the final hermetic seal and traps the atmosphere in the cavity formed in the transparent beam directing array.

As a final step, fine and gross leak test are performed on the transparent beam directing array. In accordance with an exemplary embodiment the convergence lens 1300 may be coupled to the low cap window using a lens bonding adhesive. In addition two high-density electrical connector sockets may be soldered onto the substrate 1250. The transparent beam directing array is now ready for final functional test. The configuration shown has 48 available ports to ensure that more than 40 ports will meet all requirements.

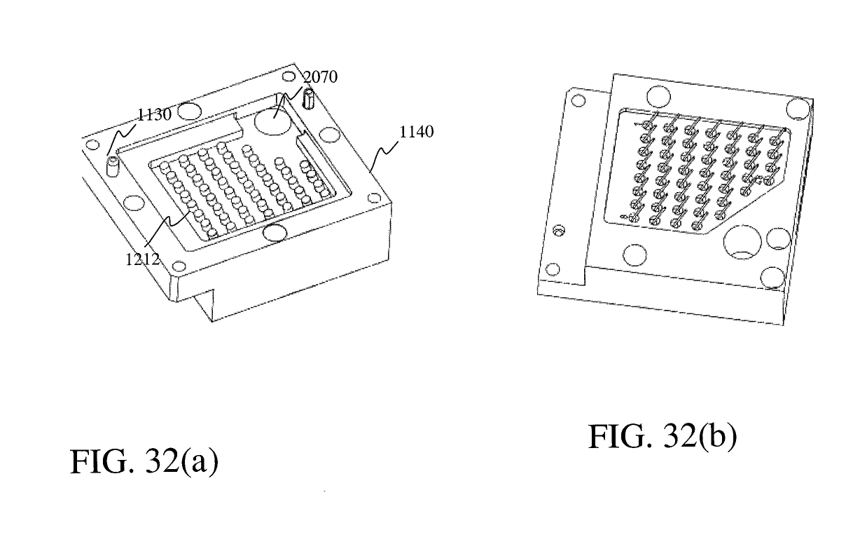

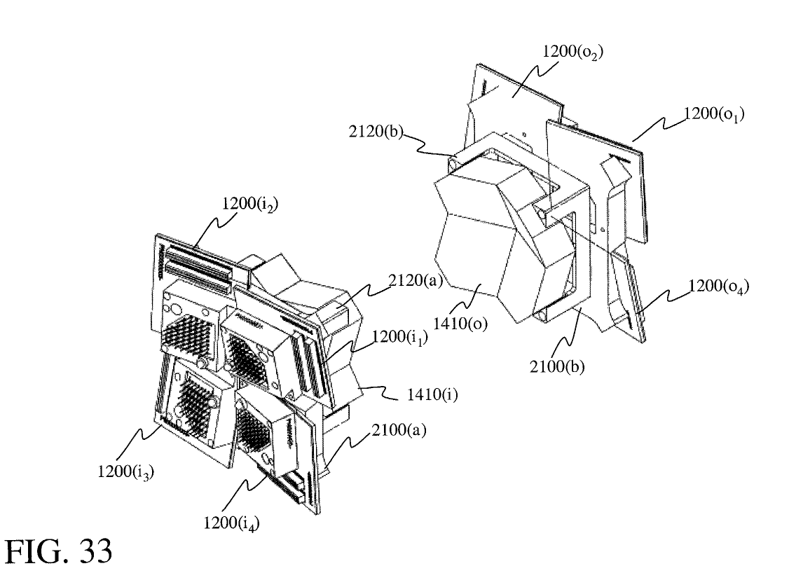

FIGS. 32(a) and (b) show top and bottom perspective views of the described exemplary collimating optics array respectively. In accordance with an exemplary embodiment the collimating optics array may comprise a collimator plate 1140 and discrete collimating optics 1212. In the described exemplary embodiment the collimator plate 1140 may be CNC machined from 400 series stainless steel. In the described exemplary embodiment holes for the collimating optics 1212 may be precisely formed in the collimator plate 1140 with respect to the alignment pins 1130, with true position on the order of about 25 μm. In accordance with an exemplary embodiment the outer diameter of the holes for the collimating optics are sized such that a collimator will slide in with minimal clearance to reduce the pointing error between the collimator and its associated beam directing device. In the described exemplary embodiment the collimator holes are about 1.25 mm and are oversized as compared to the diameter of the collimating optics by about 5 μm.

In accordance with an exemplary embodiment the collimating optics may be manufactured to minimize their targeting error at the 6.5 mm critical path from the collimator to the beam directing device. In the described exemplary embodiment the collimators are glass rod lenses with precise outer diameters. The fiber may be attached to the end of the collimating lens, forming the collimating optics. In the described exemplary embodiment the collimating optics may be separated or binned into groups in accordance with the outer diameter of the collimating optic to ensure a precise fit with the holes in the matching collimator plates.

In the described exemplary embodiment the collimating optics are passively inserted into the holes from the back of the collimator plate and held into place with a two-part silicone. The two-part silicone provides adhesion between the collimating optic and the collimator plate as well as strain relief for the fibers that are protruding.

In accordance with an exemplary embodiment the collimating plate may further comprise a breather hole 2070 that may be covered with a microfilter to allow air to be easily exchanged from the ambient air to the gap between the collimator plate and the lower window. The described exemplary microfilter reduces the risk of particulate contamination and helps avoid condensation. In accordance with an exemplary embodiment the precision alignment pins 1130 are constructed using a pin and a diamond pin. This method ensures that the alignment is not over constrained. The pin sets location while the diamond pin sets the rotation. With this method the collimating optics and the transparent beam directing array can be registered within about 25 μm.

FIG. 33 is an exploded view of the described exemplary optical switch core wherein a plurality of input tiles 1200(i₁-i₄) face a plurality of output tiles 1200(o₁-o₄). In the described exemplary embodiment, both the input and output tiles may be mounted to a web 2100(a) and (b) and a beam combiner 1410(a) and 1410(b) mounted to mounting brackets 2120(a) and (b) respectively. In the described exemplary embodiment the web 2100 contains both mounting holes (not shown) for bolting on the tiles and alignment holes (not shown) for precisely locating them. In operation the beam directing devices may compensate for small shifts in the relative placement of the input and output tiles. The two assemblies represent the input and output address planes of the switch core. In the described exemplary embodiment, the input and output assemblies may utilize common that are rotated about the optical axis of the switch core and angled with respect to the optical axis of the tile axis.

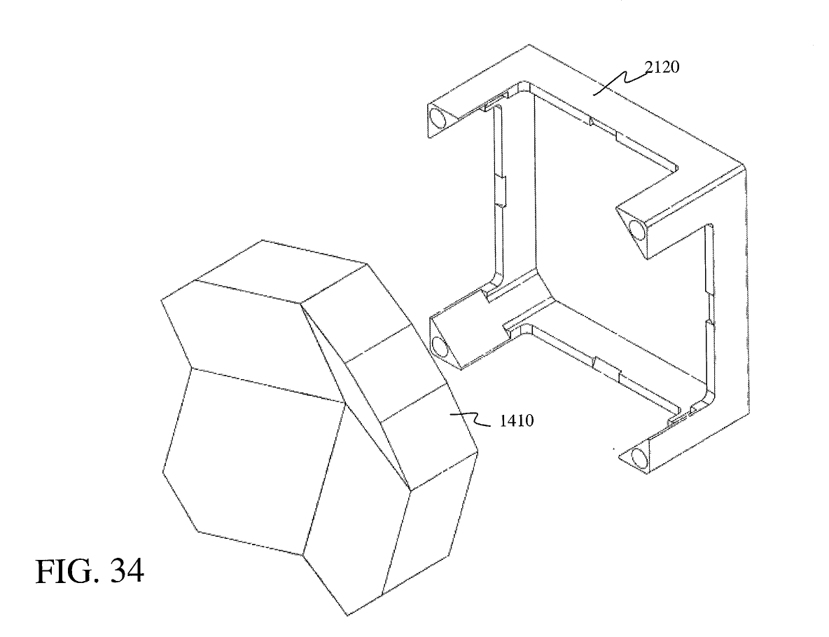

FIG. 34 is a perspective view of the described exemplary four parallel plate beam combiner 1410 and the mounting bracket 2120. In the described exemplary embodiment the four parallel plates may be bonded together and then bonded into the mounting bracket 2120. The mounting bracket is then bolted into the web (not shown).

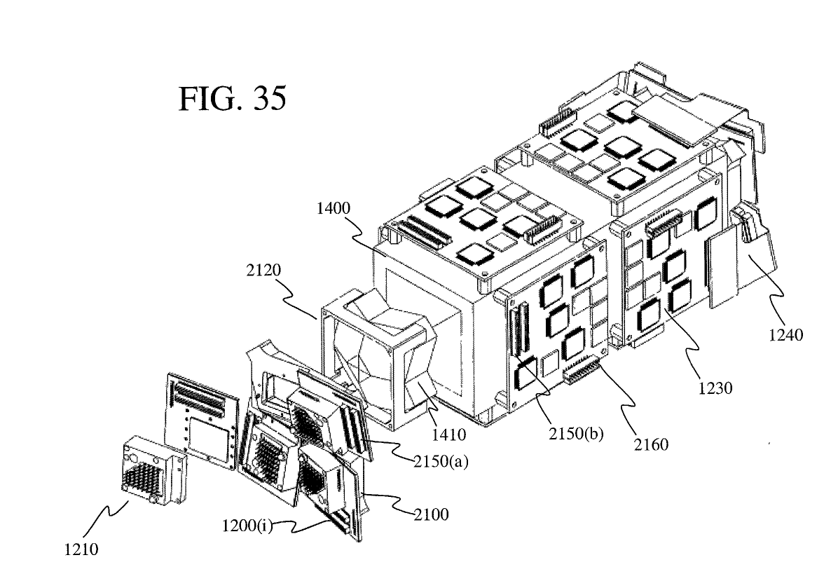

FIG. 35 shows an exploded view of the described exemplary switch core. The beam combiner 1410 is shown mounted to the mounting bracket 2120 which may then be mounted to the frame 1400. Input tiles 1200(i) are shown mounted with bolts onto the web 2100, and the collimating optics arrays 1210 are mated with the transparent beam directing array and bolted onto the web 2100.

In the described exemplary embodiment the drive electronics 1230 are mounted onto the sides of the frame 1400. A flex cable 1240 with male connectors mates with female connectors 2150(a) and (b) on both the tiles 1220 and the drive electronics board respectively. The drive electronics board may include a serial bus connector 2160 for integration into the switching control system (not shown). In the described exemplary embodiment the flex cable 1240 may comprise two or more layers formed from Kapton polyimide as is standard in the art.

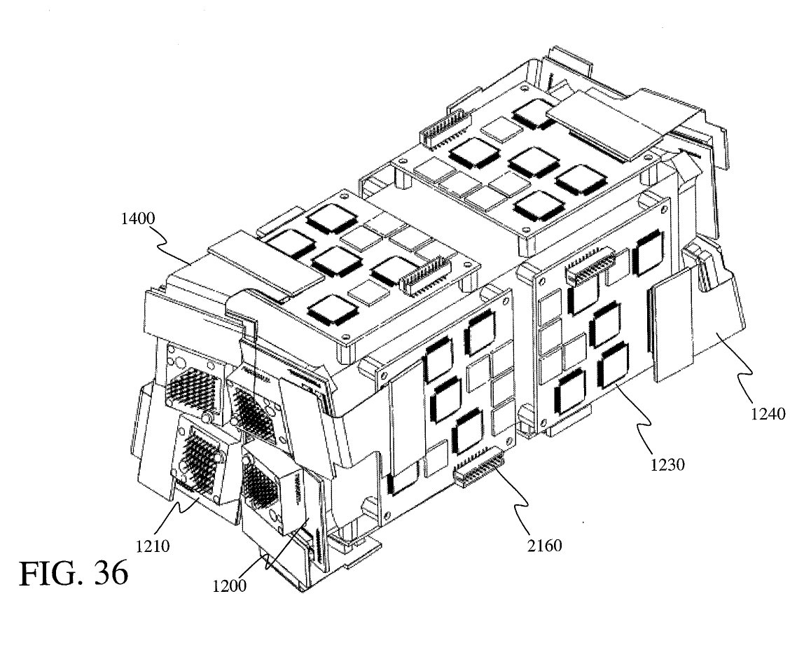

A perspective of a fully assembled optical switch core is illustrated in FIG. 36 demonstrating the advantages of the modular design. In the described exemplary embodiment input or output ports may be added in increments of tiles as required without redesign or inventorying multiple parts. In addition, repair or upgrades both in the factory or field are possible. Further, each of the components of the described exemplary optical switch core may be independently manufactured, burned-in and tested. In addition, design improvements in one component, such as, for example the drive electronics, do not ripple through the entire optical switch core. Not shown in FIG. 36 are the fiber bundles originating from each of the collimating optics arrays, the control electronics connectors and the frame mounts. In the described exemplary embodiment the frame mounts can be shock and vibration isolators as required. The described exemplary switch core may be configured as a 40×40, 40×80 up to a 160×160 cross-connect. For a 160 port switch core with a scan angle on the order of about 5° and a 6 mm² unit cell the dimensions in FIG. 36 are approximately 5″×5″×10″ long.

Although exemplary embodiments of the present invention have been described, they should not be construed to limit the scope of the appended claims. Those skilled in the art will understand that various modifications may be made to the described exemplary embodiments and that numerous other configurations are capable of achieving this same result. Moreover, to those skilled in the various arts, the invention itself herein will suggest solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention.

What is claimed is:

1. An optical switching core, comprising:
two or more input optical tiles, wherein each of said optical tiles comprises a collimating optics array for transmitting a plurality of incoming optical beams and a transparent beam directing array optically coupled to said collimating optics array for redirecting said plurality of incoming optical beams to at least one of a plurality of output ports, wherein said two or more optical tiles are rotated about an optical axis with respect to one another.

2. The optical switching core of claim 1 wherein said two or more transparent beam directing arrays comprise a plurality of beam directing devices and wherein said two or more collimating optics arrays comprise a plurality of optical collimators for transmitting each of said plurality of incoming optical beams to a unique one of said plurality of beam directing devices.

3. The optical switch core of claim 2 wherein said plurality of optical collimators comprises a plurality of glass rod lenses.

4. The optical switch core of claim 2 wherein said plurality of optical collimators comprises a plurality of microlenses.

5. The optical switch core of claim 2 wherein said two or more collimating optics arrays further comprise a collimator plate, wherein said collimator plate comprises a plurality of apertures, and wherein said plurality of optical collimators are coupled to said plurality of apertures.

6. The optical switching core of claim 5 wherein said two or more collimator plates further comprise a plurality of datums for passively aligning said two or more collimating optics arrays with said two or more transparent beam directing arrays.

7. The optical switching core of claim 1 wherein the tiles are arranged in a pinwheel configuration about a common axis.

8. An optical switching core, comprising:
an input optical tile comprising an input collimating optics array optically coupled to an input transparent beam directing array;
a second optical tile comprising an output collimating optics array, comprising a plurality of output ports, optically coupled to an output transparent beam directing array;
a frame, wherein said input optical tile is coupled to a first side of said frame and wherein said second optical tile is coupled to a second side of said frame, and wherein said input transparent beam steering array redirects a plurality of input optical beams transmitted by said collimating optics array to at least one of said plurality of output ports.

9. The optical switching core of claim 8 wherein said frame comprises a reflector optically coupled to said two or more transparent beam steering arrays for reflecting said plurality of redirected incoming optical beams to said at least one of a plurality of output ports.

10. The optical switching core of claim 8 further comprising two or more sets of drive electronics coupled to said frame for controlling said plurality of beam directing devices and two or more flex cables electrically coupling said two or more transparent beam steering arrays to said two or more sets of drive electronics.

11. An optical switching core, comprising:
two or more optical tiles, wherein each of said optical tiles comprises a collimating optics array and a transparent beam directing array optically coupled to said collimating optics array and wherein said two or more optical tiles form an NxM optical switch for redirecting a plurality of incoming optical beams to at least one of a plurality of output ports.

12. The optical switching core of claim 11, wherein at least one of the optical tiles faces at least one of the other optical tiles.

13. The optical switching core of claim 11 wherein the optical pathlength between individual collimating optics of the collimating optics array and individual beam directing devices of the transparent beam directing array is minimized.

14. The optical switching core of claim 11 wherein said transparent beam directing arrays comprise a plurality of beam directing devices coupled to a first surface of a substrate and wherein said incoming optical beams traverse said substrate.

15. The optical switching core of claim 14 wherein said substrate comprises a multilayer ceramic with a plurality of apertures wherein said plurality of incoming optical beams traverse through said plurality of apertures.

16. The optical switching core of claim 14 wherein said substrate comprises a silicon wafer having a first antireflective coating on said first substrate surface and a second antireflective coating on a second substrate surface.

17. The optical switching core of claim 14 wherein said collimating optics arrays comprise a plurality of optical collimators for transmitting each of said plurality of incoming optical beams to a unique one of said plurality of beam directing devices.

18. The optical switch core of claim 17 wherein said plurality of optical collimators comprises a plurality of glass rod lenses.

19. The optical switch core of claim 17 wherein said plurality of optical collimators comprises a plurality of microlenses.

20. The optical switch core of claim 17 wherein said collimating optics arrays further comprise a collimator plate having a plurality of apertures, wherein said plurality of optical collimators are coupled to said plurality of apertures.

21. The optical switching core of claim 20 wherein said collimator plates further comprise a plurality of datums for passively aligning said plurality of optical collimators to said first plurality of beam directing devices.

22. The optical switching core of claim 13 further comprising a window having a plurality of reflective strips on a first portion of said first window for reflecting said plurality of incoming optical beams onto said first plurality of beam directing devices and wherein said plurality of redirected optical beams traverse through a second portion of said first window.

23. A method of designing an optical switching core, comprising:
defining one or more switching core design constraints;
defining one or more switching core performance constraints;
determining diameter of incoming optical beam as a function of said switching core design constraints;
modifying at least one of said one or more switching core design constraints or at least one of said one or more switching core performance constraints as a function of the diameter of the incoming optical beam.

24. The method of claim 23 wherein defining one or more optical design constraints comprises defining port count.

25. The method of claim 24 wherein defining one or more optical design constraints comprises defining unit cell area.

26. The method of claim 24 wherein defining one or more optical design constraints comprises defining scan angle of beam directing devices.

27. The method of claim 25 further comprising defining a scan area for addressing one or more output ports as a function of said unit cell area and said port.

28. The method of claim 27 wherein further comprising defining a path length as a function with of a scan angle and said scan area.

29. The method of claim 28 further comprising defining Raleigh range as one half said path length and wherein determining diameter of incoming optical beam comprises determining diameter of said incoming optical beam in accordance with said Raleigh range.

30. The method of claim 23 wherein defining one or more optical core performance constraints comprises defining an insertion loss multiplier as a function of the diameter of said incoming optical beam.

31. The method of claim 23 wherein defining one or more optical core performance constraints comprises defining a cross talk multiplier as a function of the diameter of said incoming optical beam.
